(19) United States
(12) Patent Application Publication
(10) Pub. No.: US 2026/0244309 A1
(43) Pub. Date: Aug. 20, 2026

(54) SYSTEMS, DEVICES, ARTICLES, AND METHODS FOR DISCOVERY BASED ON MATERIAL ATTRIBUTES

(71) Applicant: LULULEMON ATHLETICA CANADA INC., Vancouver (CA)

(72) Inventors: Mirza Saquib SARWAR, Vancouver (CA); Richard John BOLTON, Vancouver (CA); Jason Lorents SULLIVAN, Vancouver (CA)

(21) Appl. No.: 18/872,083

(22) PCT Filed: Jul. 13, 2023
(86) PCT No.: PCT/CA2023/050946

§ 371 Date: Dec. 5, 2024

Related U.S. Application Data
(60) Provisional application No. 63/389,712, filed on Jul. 15, 2022.

(51) Int. Cl. G06F 3/0482; G06F 3/04847; G06T 7/90

(52) U.S. Cl. CPC G06F 3/0482; G06F 3/04847; G06T 7/90; G06T 2207/20084

(57) ABSTRACT

Embodiments described herein relate to systems, devices, articles, and methods which in operation process visual attributes of material using tangible components including at least one processor and at least one controller, for example, a sensor or an imager. In an aspect there is provided ordering a plurality of images associated with one or more materials and a plurality of reference material characterization values. The order is based on a plurality of distances between each of the plurality of reference material characterization values and an input material characterization value. The input material characterization value may be provided by a user in a discovery experience.

### TECHNICAL FIELD

The present disclosure relates to systems, devices, articles, and methods involving electrical computers, digital processing, computer interfaces, distributed systems, smart devices, digital classes and environments, processor generated environments, machine learning, digital simulation, and systems integrations.

### BACKGROUND

Web sites defined in processor-executable instruction and/or processor readable-data which when executed by processor-based devices provide information to market and controls allowing users to purchase items (e.g., goods, materials). There exists a need for improved web-based or electronic retail related processes and systems, or at least alternatives to address technical challenges and computer problems.

### SUMMARY

In an aspect, there is provided a computer system for a graphical user interface, The system has: a user device having a graphical user interface including a first portion of the graphical user interface wherein the first portion comprises a plurality of images associated with a plurality of items; at least one controller performing measurements; at least one processor communicatively coupled to the user device; and at least one non-transitory processor-readable storage device communicatively coupled to the at least one processor. The at least one non-transitory processor-readable storage device stores processor-readable data and processor-executable instructions. The processor-readable data comprises a plurality of images associated with a plurality of items, and a plurality of reference material characterization values associated with the plurality of images. When the at least one processor executes the processor-executable instructions it causes the at least one processor to: transmit control signals to the at least one sensor controller to perform measurements; receive output from the measurements performed by the at least one controller; define the plurality of reference material characterization values associated with the plurality of items in response to the output from the one or more sensors which performed the measurements; associate a respective reference material characterization value in the plurality of reference material characterization values with a material included in a respective item represented by a respective image in the plurality of images; receive a first input material characterization value; order the plurality of images associated with the plurality of items based on a plurality of distances between each of the plurality of reference material characterization values and the first input material characterization value; and automatically update, at the user device, the graphical user interface including an updated first portion of the graphical user interface by automatically moving the plurality of images associated with the plurality of items included in the first portion of the graphical user interface based on the order, the updated first portion of the graphical user interface comprising the plurality of images associated with the plurality of items in the order based on the plurality of distances between each of the plurality of reference material characterization values and the first input material characterization value.

In some embodiments, the system has at least one sensor performing a portion of the measurements, and wherein the at least one processor transmits control signals to the at least one sensor to perform the measurements, and receives output from the measurements performed by the at least one sensor.

In some embodiments, the at least one processor computes the first input material characterization value using a machine learning model to extract one or more visual attributes of a material and generate a processor readable representation of the one or more visual attributes.

In some embodiments, the at least one processor defines one or more of the plurality of reference material characterization values using a machine learning model to extract one or more visual attributes of a material and generate a processor readable representation of the one or more visual attributes.

In some embodiments, the at least one processor defines one or more of the plurality of reference material characterization values using a machine learning model to extract values from one or more swatches, wherein a swatch is a sample of visual attributes of a material.

In some embodiments, the first input material characterization value is a lower-dimensional representation of the one or more visual attributes of the material.

In some embodiments, the machine learning model is selected from the group consisting of a supervised machine learning model, a K-nearest neighbour model and a neural network.

In some embodiments, the one or more of the plurality of reference material characterization values comprise locations in a colour space.

In some embodiments, the user device is associated with a user, the graphical user interface includes a second portion comprising a control which in operation specifies a respective value of a respective visual attribute. When executed, the processor-executable instructions further cause the at least one processor to: receive the first input material characterization value provided by the user through the control included in the graphical user interface.

In some embodiments, the first input material characterization value is a value characterizing a visual attribute of a material.

In some embodiments, the value characterizing the visual attribute of the material is a numeric value characterizing the visual attribute of the material.

In some embodiments, the value characterizing the visual attribute of the material characterizes at least one attribute selected from a group consisting of: color of the material; ornamentation of the material; and texture of the material.

In some embodiments, wherein when executed, the processor-executable instructions further cause the at least one processor to: receive from the user device an input including a category filter value; and generate the plurality of items from the input including the category filter value.

In some embodiments, the category filter value is one or more values of type selected from the group consisting of: gender, target age, brand, category, color, material, popularity, price, promotion, rating, season, size, and theme.

In some embodiments, wherein when executed, the processor-executable instructions further cause the at least one processor to: compute the plurality of distances between each of the plurality of reference material characterization values and the first input material characterization value, with an input including the plurality of reference material characterization values and the first input material characterization value.

In some embodiments, wherein when executed, the processor-executable instructions further cause the at least one processor to: receive from the user device, a second input material characterization value; and generate the plurality of distances with an input including: the plurality of reference material characterization values, the first input material characterization value, and the second input material characterization value.

In an aspect, there is provided a system including a user device, at least one processor communicatively coupled to the user device, and at least one non-transitory processor-readable storage device communicatively coupled to the at least one processor. The at least one non-transitory processor-readable storage device stores processor-readable data and processor-executable instructions which, when executed by the at least one processor, cause the at least one processor to store a plurality of images associated with a plurality of items, store a plurality of reference material characterization value associated with the plurality of images. A respective reference material characterization value in the plurality of reference material characterization values is associated with a material included in a respective item represented by a respective image in the plurality of images. A respective reference material characterization value in the plurality of reference material characterization values is defined in response to an output of an imager. When executed, the processor-executable instructions further cause the at least one processor to generate a graphical user interface (GUI) including a first portion of the GUI wherein the first portion comprises the plurality of images associated with the plurality of items, and receive a first input material characterization value. When executed, the processor-executable instructions further cause the at least one processor to order the plurality of images associated with the plurality of items based on a plurality of distances or similarity measures between each of the plurality of reference material characterization values and the first input material characterization value, and update the GUI including an updated first portion of the GUI which comprises the plurality of images associated with the plurality of items in the order based on the plurality of distances or similarity measures between each of the plurality of reference material characterization values and the first input material characterization value.

In a further aspect, there is provided a method of operation in a system including at least one processor, and a user device in communication with the at least one processor. The method includes generating, by the at least one processor, a GUI including a first portion of the GUI. The first portion includes a plurality of images associated with a plurality of items. The method includes receiving, by the at least one processor from the user device, a first input material characterization value, and associating, by the at least one processor, a plurality of reference material characterization values with the plurality of images. A respective reference material characterization value in the plurality of reference material characterization values is associated with a material included in a respective item represented by a respective image in the plurality of images. A respective reference material characterization value in the plurality of reference material characterization values is defined in response to an output of one or more sensors. The method includes ordering, by the at least one processor, the plurality of images associated with the plurality of items based on a plurality of distances between each of the plurality of reference material characterization values and the first input material characterization value, and generating, by the at least one processor, the GUI which includes an updated first portion of the GUI, the updated first portion of the GUI comprising the plurality of images associated with the plurality of items in the order based on the plurality of distances between each of the plurality of reference material characterization values and the first input material characterization value.

In a further aspect, there is provided a method of operation in a system including at least one processor, at least one sensor in communication with the at least one processor, and a storage device in communication with the at least one processor. The method includes receiving, by the at least one processor from the at least one sensor, measurement of a material, produced by the at least one sensor, and extracting, by the at least one processor, from the measurement a dominant visual attribute value. The method includes assigning, by the at least one processor, a material characterization value to the material based on the dominant visual attribute value, and storing, by the at least one processor on the storage device. A record includes an identifier of the material, and the material characterization value.

In a further aspect, there is provided a system including an imager, at least one processor communicatively coupled to the imager, and at least one non-transitory processor-readable storage device communicatively coupled to the at least one processor. The at least one non-transitory processor-readable storage device stores processor-readable data and processor-executable instructions which, when executed by the at least one processor, cause the at least one processor to receive an image of a material produced by the imager, extract from the image a dominant visual attribute value, and assign a material characterization value to the material based on the dominant visual attribute value.

In another aspect, there is provided a computer implemented method of processing visual attributes of a material in a system including at least one processor and an imager. The method includes receiving, by the at least one processor, an input dataset including an image of the material produced by the imager, and providing, by the at least one processor, the image to a machine learning (ML) model. The method also includes receiving, at the at least one processor from the ML model, an output dataset including a lower-dimensional representation of the image of the material, and returning, by the at least one processor, the output dataset including a lower-dimensional representation of the image of the material.

In another aspect, there is provided a computer implemented method of training a ML model for processing visual attributes of a material in a system including at least one processor and an imager. The method includes receiving, by the at least one processor, an input dataset including a plurality of images of a plurality of materials from the imager. The method includes, for each image in the plurality of images, generating successive reconstructions for each image until reaching a stop condition, and generating a lower-dimensional representation each material included in each image. The method further includes updating a plurality of parameters for the ML model, and producing an output dataset including plurality of parameters for the ML model.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Systems, devices, articles, and methods are described in greater detail herein with reference to the following figures in which:

FIG. 1 is a schematic diagram illustrating a portion of a system including at least one server and one user device;

FIG. 2 is a schematic diagram illustrating a portion of a system including a plurality of user devices;

FIG. 3 is a wire frame diagram showing an example GUI including a control to specify one or more visual attributes of a material and a plurality of images associated with a plurality of items;

FIG. 4 is a wire frame diagram showing an example GUI including the plurality of images arranged in an order based on the one or more visual attributes of a material and one or more attributes of materials included in the plurality of items;

FIG. 5A, FIG. 5B, and FIG. 5C are wire frame diagrams illustrating example GUIs including a plurality of examples of controls, which when operated specifies one or more visual attributes of a material;

FIG. 6, FIG. 7A, and FIG. 7B are flow-diagrams illustrating implementations of a method of operation for a discovery system;

FIG. 8 is a flow-diagram illustrating an implementation of a method of operation for a system including at least one imager;

FIG. 9 is a flow-diagram illustrating an implementation of a method of operation for a system including at least one ML model;

FIG. 10 is a flow-diagram illustrating an implementation of a method of operation for a system including at least one record summarizing a plurality of discovery experiences; and

FIG. 11, FIG. 12, and FIG. 13 are schematic diagrams of various aspects of feature spaces.

In the drawings, the same reference numbers identify similar elements or acts. In the drawings, angle, size, and relative position of elements are not necessarily shown to scale. For example, some of these elements may be enlarged or positioned to improve drawing legibility. Further, the shapes of any elements as drawn, are not necessarily intended to convey any information regarding the actual shape of the particular elements and may have been solely selected for ease of illustration or recognition.

### DETAILED DESCRIPTION

The present disclosure involves systems, devices, articles, and methods which in operation define or implement one or more instances of one or more computer-implemented discovery experiences. In some embodiments, a computer-implemented discovery experience involves querying for items by one or more aspects of a material included in a respective item. The one or more aspects may be visual attributes, such as, color (e.g., hue, shade), ornamentation (e.g., embroidery, pattern, treatment), or texture.

The computer-implemented discovery experiences may, in some implementations, relate to distributed systems and provide guests (e.g., customers) an individualized discovery experience for items for sale. In some embodiments, the discovery experiences may be part of a design process and provide users with an individualized discovery experience.

Discovery experiences can allow users to filter for attributes of items. For example, in a retail experience these attributes include gender (e.g., female, male, nonbinary, agender, androgyne, transgender, cisgender, bigender, two spirit), target age (e.g., group or range), brand, category (e.g., activity, apparel type), color, material, popularity, price, promotion, rating, size (e.g., ordinal value, range), season, theme (e.g., event, setting), or the like. Color and material are two examples of filters that are traditionally implemented as filters by nominal variables. In this way, all reds are “red” and pink is or is not red depending on the configuration. And further, there is no notion of the relative distance between pairs of colors like (red, blue) compared to (red, pink). Similarly, when the user selects wool as a value for a material filter, all wools can be included regardless of characteristics and similar natural fibers are excluded. There is also no ability to order material based on similarity. For example, the pair (denim, canvas) are closer in texture than the pair (denim, rayon); or consider closer sets of pairs like (cashmere, merino) versus (cashmere, qiviut). That is color and material as filters have categorical (e.g., nominal) scales of measure and filters based on these are more like tags. Tags may be misapplied.

The present disclosure shares systems, devices, articles, and methods to provide a user an individualized experience including filters based on numeric values and rank or order of items based on distances between numeric values, or other types of similarity measures between different types of values. In some embodiments discussed, the filters and orders are based on numeric values corresponding to visual aspects of materials. In this way, a guest can have an individualized discovery experience by specifying visual aspects of items, for example a garment, and receiving representation of a plurality of items ranked by the specified visual aspects of items.

Systems, devices, articles, and methods described herein may include attributes of materials such as chemical, mechanical, and physical properties as measured by sensors through visual attributes of material. The one or more materials included in an item, for example, an article of manufacture, such as, apparel (e.g., accessory, garment, shoes), component, or raw material. In some embodiments, the aspect is a visual aspect of the material included, such as, color (e.g., hue, shade), ornamentation (e.g., embroidery, pattern, treatment), or texture.

Color may be defined in a color model such as, an additive model such as, RGB (e.g., with colors represented by 8 bits for each of the three component colors), Hue Saturation and Lightness (HSL). Color can be hue, hue and shade, shade, and the like. Color may be defined in a subtractive color model such as CMY and CMYK.

The visual aspects of a material include, ornamentation or two-dimensional elements placed on the material for decorative purposes, such as, embroidery, or pattern, treatment. Embroidery includes, application of a design comprised of fibers to a material by one or more needles. A pattern refers to repeating decorative elements which are all the same. A pattern can be applied to a material (e.g., printed, embossed) or formed in a material (e.g., woven fabric). Ornamentation refers to decorative elements placed on the surface of a material or found on the surface of a finished item, such as, aperiodic arrangement of elements. Treatment refers to processes applied to a material that changes the visual appearance element placed on the surface of a material or found on the surface of a finished item (e.g., tie dye, text).

Texture is a spatially recurring physical element in a material. The recurrence or spatial frequency can be regular or irregular. Texture may be measured by imaging the surface of a material using one more sensors described herein.

Embodiments of systems, devices, articles, and methods described herein may be described with reference to entities such as, user, guest, and merchant. The entities can interact in different environments or settings. For example, the entities can interact in a processor generated environment (PGE) (e.g., augmented reality, virtual reality).

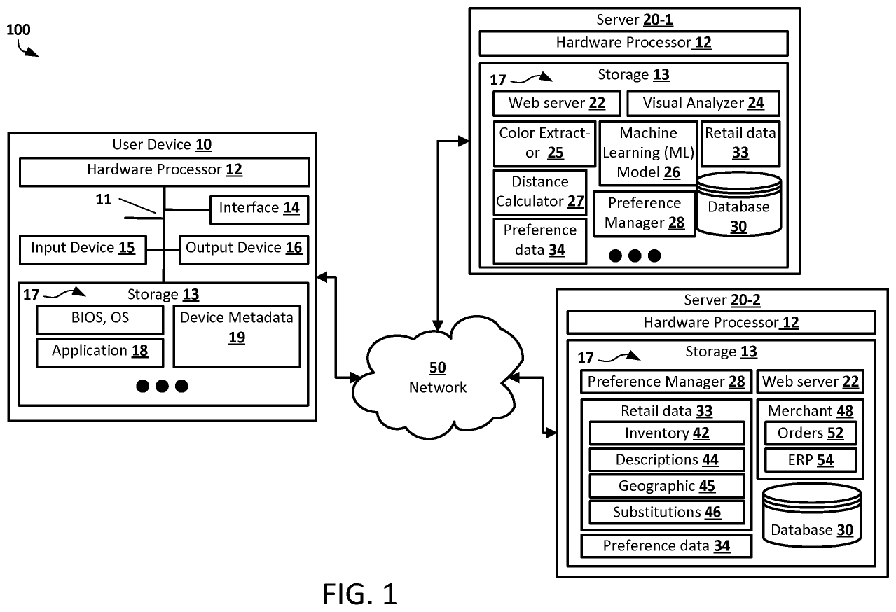

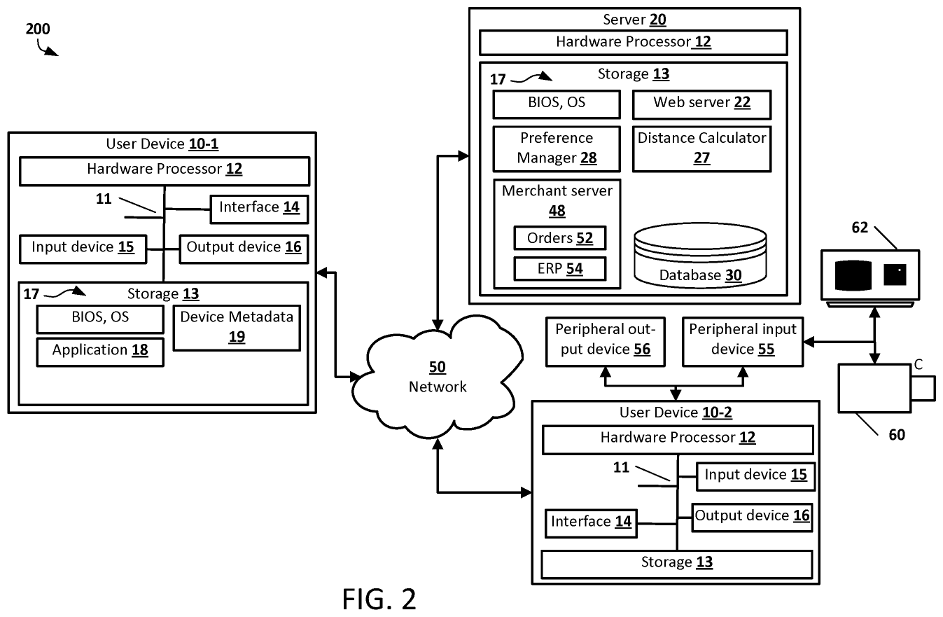

Looking at the drawings in overview note the following. FIG. 1 includes a user device and at least one server. FIG. 1 may be associated with a discovery experience where the first user device is associated with a guest. In some embodiments, FIG. 2 includes a first user device and a second user device. The second user device may be associated with a second guest, an employee, or the like.

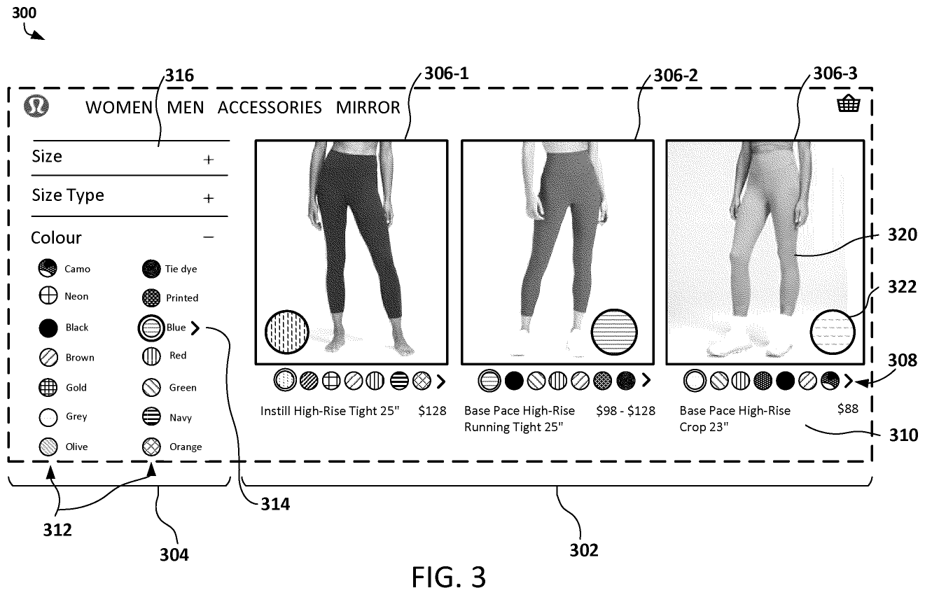

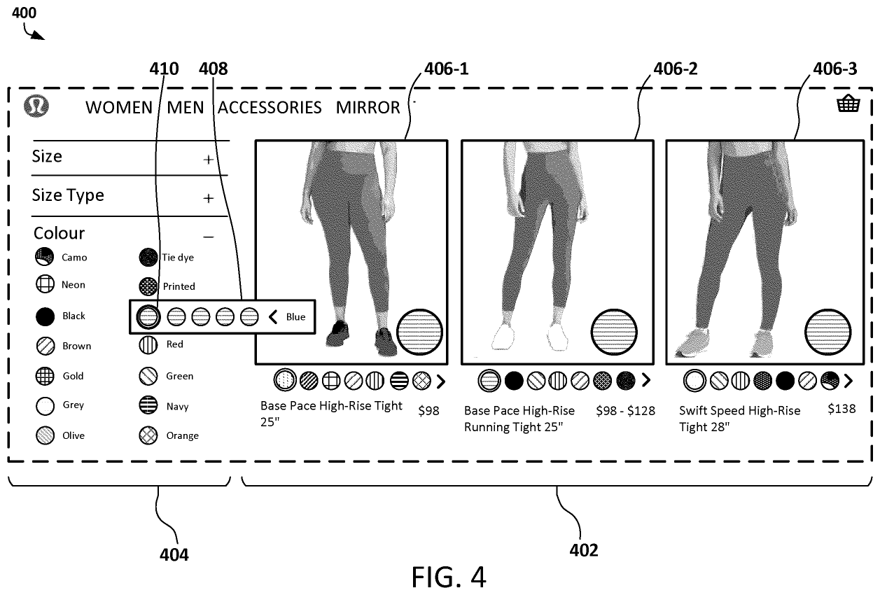

FIGS. 3, 4, 5A, 5B, and 5C are wire frame diagrams showing examples of GUIs including controls or ordered presentation of images. In particular, FIG. 3 includes a plurality of images in an unhelpful order and FIG. 4 includes the images in an order based on, in part, a value provided by a user through a control such as those shown in FIGS. 3, 4, 5A, 5B, and 5C to provide an improved visual representation of the images.

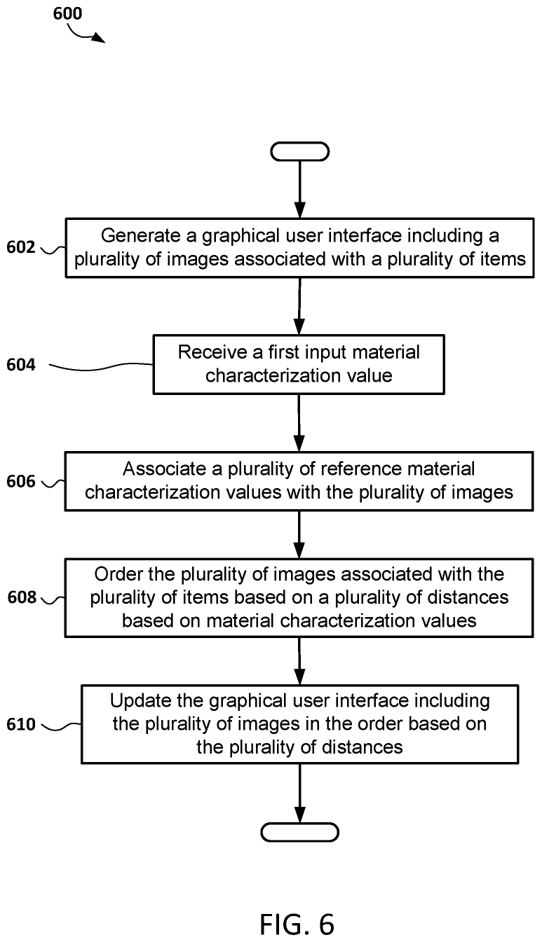

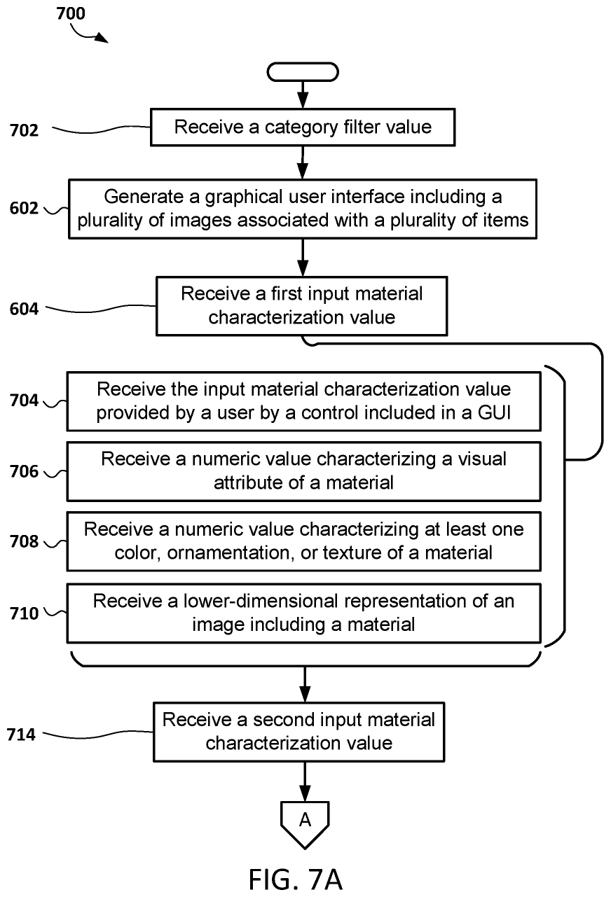

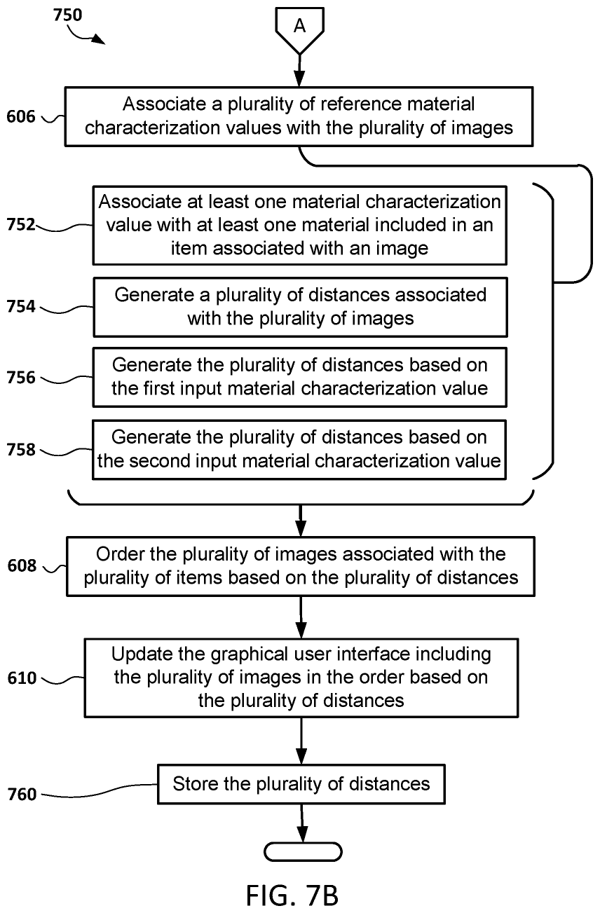

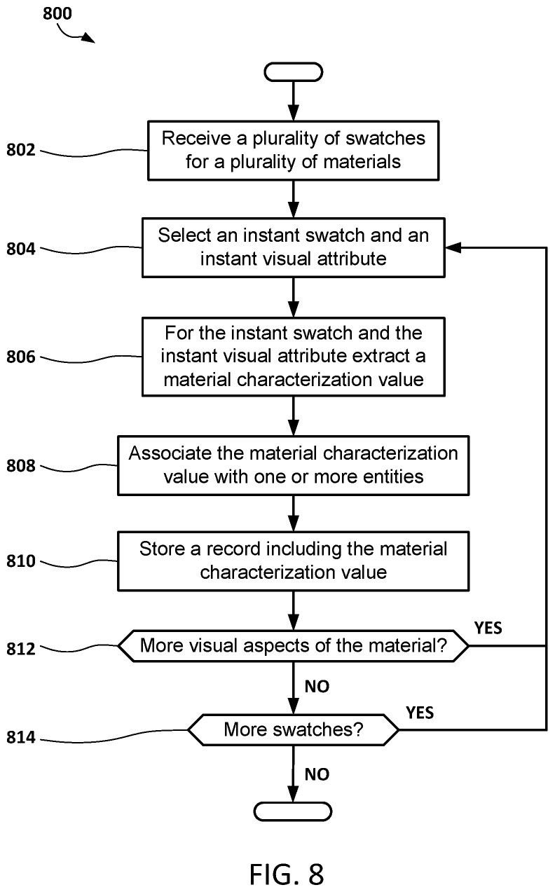

FIGS. 6, 7A, 7B, 8, 9, and 10 illustrate exemplary methods of operation for systems, such as, those shown in FIG. 1 or 2. In some embodiments, FIGS. 6, 7A, and 7B are associated with a first user (e.g., a guest) enjoying a discovery experience. In some embodiments, FIGS. 8, 9, and 10 are associated with defining aspects of a discovery experience.

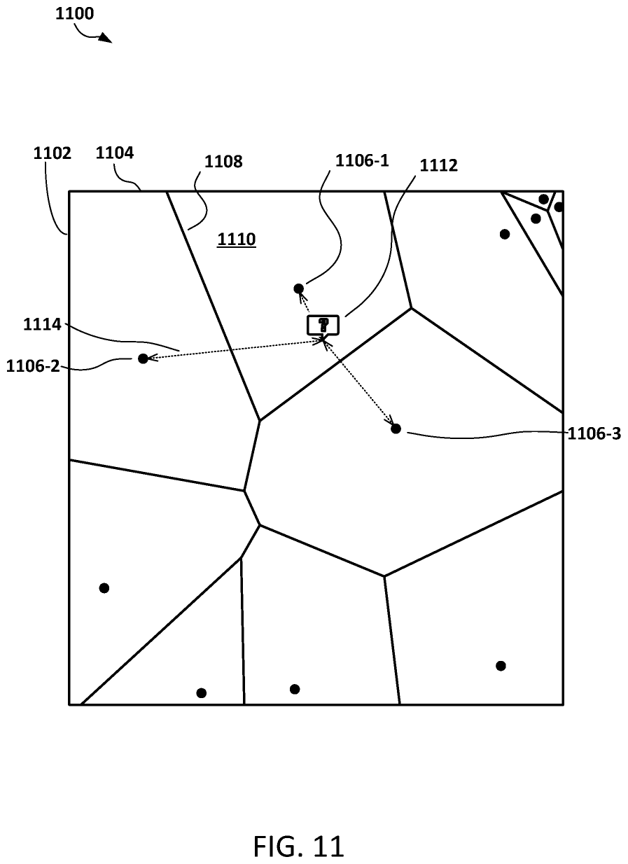

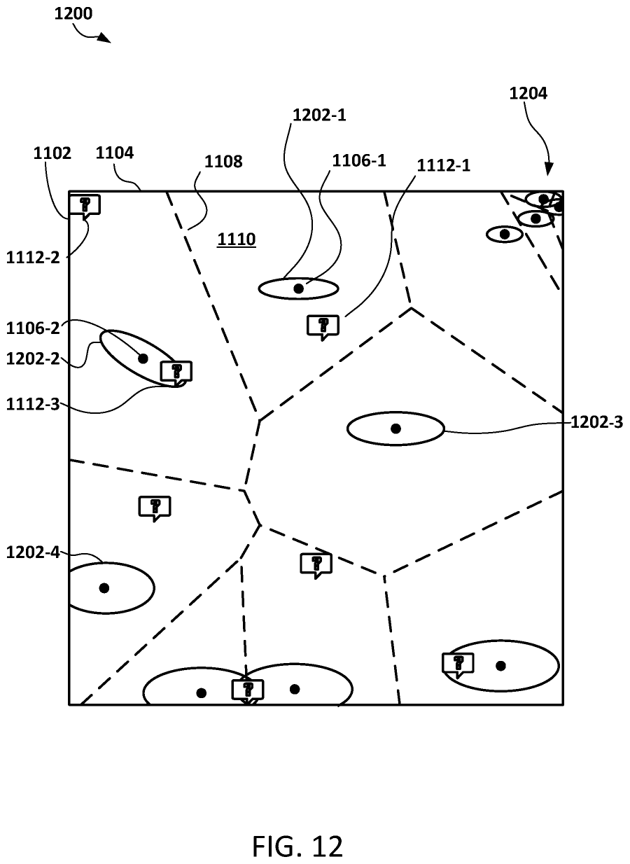

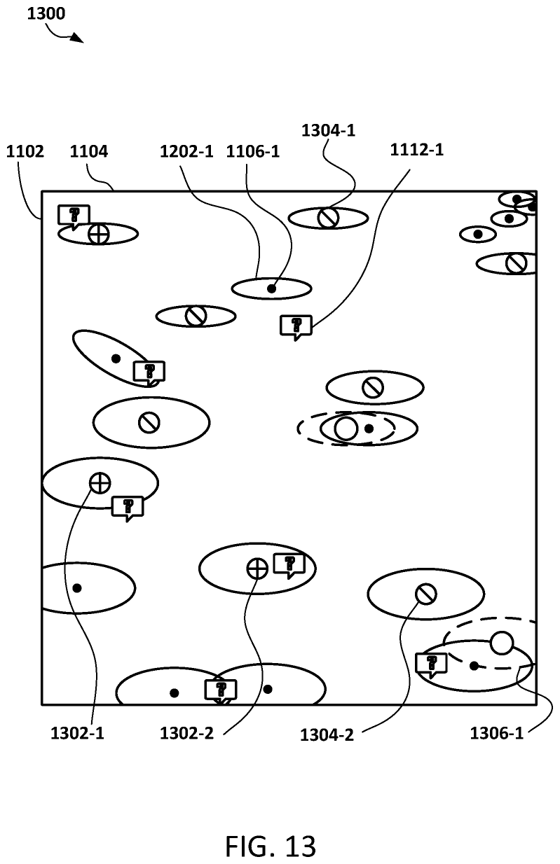

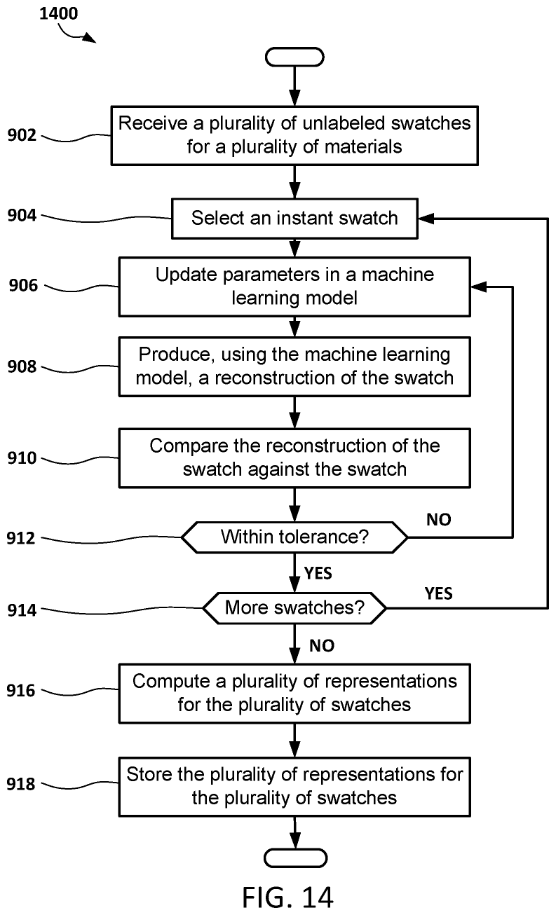

FIGS. 11, 12, and 13 are schematic diagrams illustrating various aspects of feature spaces including locations for a plurality of materials, guest requests, boundaries between parts of the spaces, or the like.

Turning to FIG. 1 which shows an exemplary system 100 in accordance with the systems, devices, articles, and methods of embodiments described herein. System 100 is an example of a system that in operation defines, tests, or provides a discovery experience. Various components of system 100 described or shown are optional in presence and numbers (e.g., omitted, present in a plurality, present singly), or may be split or combined according to various embodiments described herein. System 100 includes user device 10, at least one server 20, database(s) 30 on non-transitory storage devices 13, and a network 50 communicatively coupled to user device 10 and at least one server 20. User device 10 and at least one server 20 are processor-based devices that include at least one hardware processor 12.

User device 10 includes hardware processor 12 communicatively coupled to and operable to access a storage device 13. User device 10 further includes a bus 11 communicatively coupled to processor 12 and storage device 13. Bus 11, in some embodiments, couples processor 12 to network interface subsystem 14, input device 15, or output device 16. In some embodiments, user device 10 includes one or more of network interface subsystem 14, input device 15, or output device 16, including a plurality of each device or sub-system.

The processor 12 is at least one processor or a plurality of processors. Processor 12 may be any logic processing unit, such as one or more central processing units (CPUs), cores in processors, application-specific integrated circuits (ASICs), digital processors, digital signal processors (DSPs), graphics processing units (GPUS), microprocessors, network processors (NPs), programmable gate arrays (PGAs), programmed logic units (PLUS), or the like.

Network interface subsystem 14 comprises communication circuitry to support bidirectional communication of processor-readable data, or processor-executable instructions between a first component (e.g., user device 10) and one or more other components in system 100. Network interface subsystem 14 may employ communication protocols (e.g., FTP, HTTPS, SSH, TCP/IP, SOAP plus XML) to exchange processor-readable data, or processor-executable instructions over network 50 (e.g., ETHERNET®, Internet, LAN, WAN) or a non-network communication channel (not shown), such as, a serial connection, a parallel connection, wireless connection (e.g., BLUETOOTH® (IEEE 802.15.1), near-field communication, WIFI® (IEEE 802.11)), fiber optic connection, combinations of the preceding, or the like.

In some embodiments, at least one server 20 is communicatively coupled to user devices 10 through network 50. Thus, processor-executable instructions or processor-readable data may be transferred between user device 10 and at least one server 20 through network 50, or stored on a storage device accessible through network 50.

The storage device 13 is a concrete non-transitory hardware component comprising at least one non-transitory processor-readable storage medium including volatile memory or non-volatile memory data storage elements, or a combination thereof. Storage device 13 includes or stores processor-executable instructions and/or processor-readable data 17 associated with the operation of system 100. Execution of processor-executable instructions and/or processor-readable data 17 causes a processor, such as processor 12, to carry out various methods and actions, for example, by network interface subsystem 14, user device 10, at least one server 20, or the like. Processor-executable instructions and/or processor-readable data 17 can, for example, include a basic input/output system (BIOS), an operating system (OS), peripheral drivers (not shown), user device application 18, device metadata 19, or the like.

User device application 18 may be a web browser, specific function application (e.g., app, smart phone application), applet, or the like. User device application 18 may include processor-executable instructions designed to perform a specific function other than the one relating to the operation of the user device 10. In some embodiments, user device application 18 is a social network client which in operation interacts with a social network service provided by server(s) 20. In some embodiments, user device application 18 is a web browser which interacts with content provided by server(s) 20.

In some embodiments, a first user may select user device application 18 to find an item including a desired visual attribute of a material, e.g., texture of one material included in the item. In some embodiments, the first user, e.g., a guest to a merchant, may select user device application 18 for a different purpose, e.g., social network client, but operates user device application 18 to discover an item. In some embodiments, a second user such as an employee of a merchant may be issued user device 10 or user device application 18 to collect swatches to create reference material characterization values of one or more materials or items.

In some embodiments, device metadata 19 includes information associated with the user device 10 or a user of user device 10. The information associated with the user device 10 may include OS, device capacity (e.g., memory, processor speed), input and output subsystem or peripheral device capability (e.g., touch screen, screen resolution, camera resolution, video camera, haptic displays, haptic input, augmented reality glasses, virtual reality headsets), or the like.

The user associated with user device 10 may be a guest, consultant, employee, or the like. A guest may be a customer to a merchant, such as, a customer or a potential customer. The user may be an employee or consultant to a merchant or a partner to a merchant. In some embodiments, device metadata 19 includes processor-readable data associated with the user of user device 10 selected from a group comprising of a unique ID, age, age range, gender, preferences (e.g., activity, color, size) activity history, one or more communities, language, location or region, membership level, membership history, purchase history, navigational history, assigned products, certifications, employment tenure, or the like.

In some embodiments, a plurality of users participates in system 100 through an associated (e.g., own, shared) user device 10 to exchange processor-executable instructions or processor-readable data with at least one server 20 in manners described further herein. For simplicity of illustration, only one user device 10 and two servers 20 are shown in FIG. 1; however, a system can include a plurality of user devices. See, for example, FIG. 2.

The system 100 is not limited to a particular configuration and different combinations of components can be used for different embodiments. For example, servers or user devices could form a peer-to-peer network where the aggregate of connections forms a communicative coupling. Furthermore, while system 100 shows two servers 20 and two databases 30 as an illustrative example, system 100 extends to different numbers and arrangements of servers 20 and databases 30 (such as a single server communicatively coupled to a single database). The servers 20 can be the same or different types of devices.

The exemplary system 100 shown in FIG. 1 includes at least one server 20 and as illustrated server 20-1 and server 20-2. The at least one server 20 provides, receives, and manages data and services for other components of system 100, such as, user device 10 and another server (e.g., server 20-1 with respect to server 20-2). In some embodiments, server 20-1 stores processor executable instructions, which when run, define values used to provide discovery experiences. In some embodiments, server 20-1 stores processor executable instructions, which when run, receives input defined values used to provide a discovery experience.

In some embodiments, server 20-1 stores processor executable instructions, which when run, analyze visual attributes of a material or item. In some embodiments, server 20-1 stores processor executable instructions, which when run, provide a color extractor, a texture extractor, or the like. In some embodiments, server 20-1 stores processor executable instructions, which when run, provide a machine learning (ML) model to, at least, extract features of visual attributes of a material or item. In some embodiments, server 20-1 stores processor executable instructions, which when run, provide a distance calculator or rangefinder to determine a distance or similarity measure between a first material characterization value and a second material characterization value.

The at least one server 20 includes hardware processor 12 communicatively coupled to and operable to access a non-transitory storage device 13 and database 30 by a bus or buses (not shown). In some embodiments, the bus(es) couple processor 12 to a network interface subsystem, input subsystem, or output subsystem (all not shown).

Storage device 13 includes or stores processor-executable instructions and/or processor-readable data 17 associated with the operation and control of system 100. Execution of processor-executable instructions and/or processor-readable data 17 causes processor 12 or the at least one server 20 to carry out various methods and actions. Processor-executable instructions and/or processor-readable data 17 can, for example, include BIOS, OS, peripheral drivers (all not shown), a web server 22, visual analyzer 24, color extractor 25, ML model 26, rangefinder or distance calculator 27, preference manager 28, or the like. In some implementations visual analyzer 24 may include one or more of color extractor 25, ML model 26, and distance calculator 27. In some implementations preference manager 28 may include one or more of visual analyzer 24, color extractor 25, ML model 26, and distance calculator 27. In some embodiments, processor-executable instructions and/or processor-readable data 17 includes processor-readable data used in the operation of system 100 and may be arranged in a plurality of data sets like retail data 33, preference data 34, or the like. In some embodiments, processor-executable instructions and/or processor-readable data 17 includes database 30.

In some embodiments, system 100 includes one or more databases. Server 20-1 may implement database 30. Storage device 13 may include processor-executable instructions and/or processor-readable data which when executed by a processor implements database 30. At least one server 20 may store data located in databases 30 within memory or disk. However, in some embodiments, servers 20 include processor-executable instructions which when executed access, modify, or write data on a remotely located database.

The web server 22 includes processor-executable instructions or processor-readable data which when executed cause server 20-1 to provide processor-executable instructions or processor-readable data by network 50, other channels, or networks. In some embodiments, web server 22 receives requests by a protocol (e.g., HTTP(S)) for one or more resources and responds with the content of that one or more resources or ancillary messages such as an error message. The content may be provided in a document model and encoded in a markup language such as HTML or XML. The content can include images including video and PGE assets. Several suitable servers are commercially available such as those from Apache, Google, Microsoft, and Nginx.

In some embodiments, visual attribute analyzer or visual analyzer 24 includes processor-executable instructions or processor-readable data which when executed cause a processor, such as processor 12, to create one or more material characterization values. The visual analyzer may receive swatches from user device 10, input device 15, database 30, or the like. A swatch is a sample of a material intended to demonstrate visual attributes of a larger piece of the material. A swatch can be a tangible item or an image including an image generated by user device 10, e.g., 250 pixels by 250 pixels.

In some embodiments, visual analyzer 24 includes processor-executable instructions or processor-readable data which when executed cause a processor to analyze color, ornamentation, or texture. In some embodiments, the material characterization value is a numeric value. The numeric value may represent color, ornamentation, or texture. In some embodiments, the material characterization value is a non-numeric value representing color, ornamentation, or texture. In some implementations, the non-numeric value is a label to a numeric value or the non-numeric value can be converted into a numeric value representation. Accordingly, the processes and systems described herein can compute distances or similarity measures for different types of material characterization values.

In some embodiments, color extractor 25 includes processor-executable instructions or processor-readable data which when executed cause a processor, such as processor 12, to create one or more material characterization values based on one or more colors. In some implementations, color extractor 25 includes a color palette extractor which when executed extracts one or more colors from a swatch and stores them as a palette of colors. Different color palette extractors can be used to extract colors from a swatch and to generate a color palette for the swatch.

In some embodiments, ML model 26 includes processor-executable instructions or processor-readable data which when executed cause a processor, such as processor 12, to interpret a swatch. ML model 26 may when executed extract one or more visual attributes of a swatch. In some embodiments, ML model 26 includes processor-executable instructions or processor-readable data which when executed cause a processor to create a processor-readable representation of a visual attribute of a material in a swatch, e.g., a lower-dimensional presentation, a set of values from a hidden layer in a ML model, or a location in a feature space. The ML model can be a computer model that encodes machine executable instructions to configure a hardware processor to implement operations to process input data and generate output data. The ML model can be trained using training data, and updated using feedback data. The ML model can be the output of the training process and can be instructions to configure hardware processors to detect patterns and generate values as output data. There can be different types of ML models 26. Embodiments described herein can involve automatically generating and transmitting control signals relating to instructions to one or more hardware components to improve and control the computer hardware functionality. For example, control signals can be sent to a display device to control the display of visualizations relating to the graphical user interface (GUI), such as updating the GUI by moving items based on computed orders for the items, for example.

In some embodiments, distance calculator 27 includes processor-executable instructions or processor-readable data which when executed cause a processor, such as processor 12, to provide a distance or similarity measure between a first material characterization value and a second material characterization value. For example, an input value and a reference value. In some implementations, distance calculator is a rangefinder in a feature space. The distance calculator 27 includes processor-executable instructions which when executed cause a processor to provide a plurality of distances, a first material characterization value and a plurality of material characterization values.

In some embodiments, preference manager 28 includes processor-executable instructions or processor-readable data which when executed cause a processor, such as processor 12, to manage the preferences of users for visual attributes of materials. For example, at least one preference of one user with respect to one or more visual attributes of materials. Preference manager 28 may include processor-executable instructions or processor-readable data which when executed cause a processor to receive an input material characterization value, invoke distance calculator 27 to provide a plurality of distances (or other type of similarity measure), order a plurality of images based on the distances and return the ordered plurality of images.

In some embodiments, preference manager 28 includes processor-executable instructions or processor-readable data which when executed cause a processor to manage a plurality of preferences of a plurality of users. Preference manager 28 may, when executed, aggregate or summarize the plurality of preferences of the plurality of users. For example, summarize the preferences of a user for one or more visual attributes.

In some embodiments, web server 22, visual analyzer 24, preference manager 28, and other processor-executable instructions include different types of processor readable data to define or provide a discovery experience. Examples include processor readable retail data 33, and preference data 34. In some embodiments, server 20-1 includes storage device 13 storing therein retail data 33 or preference data 34 that are copies or near copies of retail data 33 or preference data 34 stored in another server, such as server 20-2.

In some embodiments, retail data 33 includes processor-readable data about one or more merchants and may be used by a web server 22, visual analyzer 24, preference manager 28, and other processor-executable instructions to prepare or present a plurality of images and elements of a GUI for a discovery experience.

In some embodiments, preference data 34 includes processor-readable data about one or more users. Aggregate records drawn preference data 34 may be used to determine if further visual attributes are needed in a plurality of items. See further description herein at, at least, FIG. 11.

In some embodiments, server 20-2 includes processor-executable instructions which when executed by a processor cause the processor to provide and manage a discovery experience. The discovery experience may be for selecting an item to purchase, a component to evaluate, or a material to use.

Processor-executable instructions and/or processor-readable data 17 can, for example, include a BIOS, an OS, or peripheral drivers (all not shown), a web server 22, visual analyzer 24, color extractor 25, ML model 26, rangefinder or distance calculator 27, preference manager 28, merchant server 48, and database 30 storing a plurality of data sets such as one or more retail data 33, and preference data 34.

In some embodiments, preference manager 28 includes processor-executable instructions which when executed by a processor cause the processor to receive an input material characterization value and provide a GUI including ordering of items based on proximity to the input material characterization value. In this way server 20-2 can be optimized to provide discovery experiences and server 20-1 allows users to provide data used in a discovery experience. Further aspects of preference manager 28 are described in relation to FIG. 2. The server 20-2 generates and updates the GUI to provide an improved visualization of images for the discovery experiences. The improved visualization of images provides discernible effects as the GUI displays the images on different electronic devices, for example. Further, display screens have display size constraints so updating the GUI with ordered images optimizes use of the limited size of the display screens.

Retail data 33 may include one or more subsets such as inventory data 42, item descriptions 44, geographic model 45, substitution model 46, promotion model (not shown), or the like. Inventory data 42 may include processor-readable data such as numbers, locations, and other attributes of items. Geographic model 45 may include processor-readable data on location varying aspects of the inventory or offering items for sale including regional availability, regional pricing, or regional sizing. The substitution model 46 may include processor-readable data on alternative items, such as, similar item matching, color matching, cross-sell, upsell, or the like. Thus, the substitution model 46 may include suggestions even if an item is available, e.g., upsell, promoting feel-state compatibility, cross-sell, excess inventory. The substitution model 46 may include or invoke preference manager 28 or distance calculator 27.

In some embodiments, merchant server 48 includes processor-executable instructions and/or processor-readable data which when executed by a processor cause the processor to process orders, and maintain records. In some embodiments, merchant server 48 can access database 30 to read, edit, and write records. Merchant server 48 may include an order management subsystem 52 or an enterprise resource planning subsystem (ERP) 54. The ERP 54 includes processor-executable instructions and/or processor-readable data which when executed by a processor cause the processor to maintain records for accounting, inventory, logistics, suppliers, tracking, and reporting. Merchant server 48 may include processor-executable instructions and/or processor-readable data for inventory management which when executed by a processor cause the processor to provide numbers, location, and other attributes of items.

Turning to FIG. 2 which shows an exemplary system 200 in accordance with the present systems, devices, articles, and methods. System 200 is an example of a system that when operated defines or manages a discovery experience for a first user (e.g., guest, customer) at a first user device 10-1. In some embodiments, system 200 includes a second user device (e.g., user device 10-2) which when operated by a second user (e.g., employee) provides swatches for materials and manages visual attributes of materials. The visual attributes may be later used in a discovery experience provided by server 20. Various components of system 200 described or shown are optional in presence and numbers (e.g., omitted, present in a plurality, present singly), or may be split or combined. System 200 includes a first user device 10-1, a second user device 10-2, a server 20, and a network 50 communicatively coupled to the at least one user device 10 and server 20.

The exemplary system 200 shown in FIG. 2 includes at least one user device 10, such as illustrated user device 10-1 and user device 10-2. A respective pair of user devices in a plurality of user devices, such as user device(s) 10 may be the same type or different types of devices. The at least one user device 10 includes hardware processor 12 communicatively coupled to and operable to access storage device 13, network interface subsystem 14, input device 15, or output device 16 by bus 11.

In some embodiments, the at least one user device 10 comprises storage device 13 that includes or stores processor-executable instructions and/or processor-readable data 17. In some embodiments, processor-executable instructions and/or processor-readable data 17 includes a BIOS, an OS, peripheral drivers (not shown), user device application 18, device metadata 19, or the like.

In some embodiments, user device 10-2 includes peripheral input device 55. In some embodiments, user device 10-2 includes peripheral output device 56. In various embodiments, different user device types are formed from combinations of different types of user device 10-2, peripheral input device 55, and peripheral output device 56.

According to some embodiments, user device 10 is a mobile device such as a smartphone, although in other embodiments user device 10 may be any other suitable device that may be operated and interfaced with by a user. For example, user device 10 may comprise a laptop, a personal computer, an interactive kiosk, a smart mirror, a wearable device (e.g., smart watch), a tablet device, or the like. User device 10, may include multiple types of user devices and may include a combination of devices within system 200. In some embodiments, user device 10 includes one or more input device 15 or one or more output device 16.

The input device 15 can include a sensor or a controller that can perform measurements or operations relating to swatches, materials, and items. These measurements or operations define swatches, or identify visual attributes, for example. Examples of sensors and controllers are disclosed herein in reference to, at least, input devices disclosed in FIGS. 1 and 2.

The output device 16 can present a GUI such as those disclosed in FIGS. 3, 4, 5A, 5B, and 5C. This can be defined in processor-executable instructions which, when executed by processor 12 causes the output device 16 to display the GUI.

Examples of input device 15 and peripheral input device 55 include different types of input devices like controllers and sensors and examples of output devices 16 and peripheral output device 56 include output devices like display and annunciators as found in: a smart phone, a tablet, a computer, a smart mirror, a wearable device (e.g., smart clothing, smart watch, smart jewelry, myographic band), an imager (e.g., camera, still camera, motion camera, color scanner, colorimeter, spectrocolorimeter, spectrophotometer, other imager), a keyboard, a pointer device, a touch screen, a haptic interface (e.g., haptic display, haptic glove, haptic footwear), a connected device (e.g., a yoga mat, a vehicle, cardiovascular exercise equipment, isometric or isotonic exercise equipment), a smart audiovisual system (e.g., smart speaker, lighting system), a wearable sensor (e.g., breathing monitor, blood glucose monitor, EEG, myographic band, heart rate monitor, blood oxygen monitor), an interface for processor generated experiences (e.g., headset, goggles, gloves, controllers for artificial, augmented, augmented or virtual reality), or the like.

System 200 includes at least one sensor which in operation measures one or more visual attributes of a material. For example, user device 10-2, input device 15, or peripheral input device 55 may include or by couple to include at least one sensor. The at least one sensor in operation creates a swatch or provides an output upon which a value representing a visual attribute of a material is based. In some implementations, system 200 includes an imager, for example, coupled to user device 10-2. In some embodiments, user device 10-2 includes or is coupled to a camera 60. In some implementations, user device 10-2 is coupled to bench-top measurement device 62. These measurements or operations can be used to define or identify color, for example. Systems and methods described herein, e.g., system 100, system 200, and method 800 in FIG. 8, may include an imager. For example, a tangible device that in operation generates a visible image of something, and employed in techniques, such as, photography, radar, lidar, or ultrasound. The imager may process electromagnetic waves, such as, infrared, visible, and ultraviolet. In some implementations input device 15 or peripheral input device 55 include an imager which in operation extracts a texture from a material. In some embodiments, the imager provides optical and/or digital magnification. In some embodiments, the imager creates an image of at least a portion of a material. The image may include one or more visual attributes of the material.

In some implementations input device 15 or peripheral input device 55 include an imager which in operation extracts one dominant color or a small plurality of dominant colors from a material. For example, up to five dominant colors. In some implementations, user device 10-2 or peripheral input device 55 is an imager such as a color scanner, e.g., a colorimeter or spectrocolorimeter. In some embodiments, system 200 includes a colorimeter or device that helps specific solutions to absorb a particular wavelength of light. In some implementations, a user makes use of an imager such as a spectrophotometer which in operation measures the spectral reflectance, transmittance, or relative irradiance of a color sample. In some implementations, user device 10-2 or peripheral input device 55 includes, as an imager a spectrophotometer such as benchtop device (e.g., bench-top measurement device 62) or handheld device (e.g., imager, camera 60). Example embodiments can use different types of spectrophotometers.

In some implementations user device 10-2, input device 15, or peripheral input device 55 comprise an imager which in operation extracts a texture from a material. The imager may capture infrared or ultraviolet images that are less influenced by material color or ornamentation. In some embodiments, the user device 10-2 runs an application like ADOBE® SUBSTANCE 3D SAMPLER (available from Adobe Inc., San Jose, CA, US), to capture images of a material. In some implementations user device 10-2 includes processor-executable instructions which when executed create from an image a digital height map of the material.

Input device 15 or a peripheral input device 55 can work in cooperation with output device 16 or peripheral output device 56 to perform measurements or further operations. For example, an output device 15 may be a screen displaying an image with color and intensity suitable to create a uniform light condition suitable for capture of an image by Input device 15, e.g., a camera. Uniform lighting may be used for one or more of color, ornamentation, or texture. In some embodiments, peripheral output device 56 may include a lighting system to provide uniform lighting, e.g., model light, flash.

The server 20 includes hardware processor 12 communicatively coupled by a bus or buses (not shown) to storage device 13, network interface subsystem, input subsystem, and output subsystem (not shown).

Storage device 13 includes or stores processor-executable instructions and/or processor-readable data 17 associated with the operation of system 200. Execution of processor-executable instructions and/or processor-readable data 17 causes processor 12 or server 20 to conduct various methods and actions. Processor-executable instructions and/or processor-readable data 17 can, for example, include a BIOS, an OS, or peripheral drivers (all not shown), a web server 22, distance calculator 27, preference manager 28, merchant server 48, and database 30 storing a plurality of data sets such as one or more retail data 33, and preference data 34. Merchant server 48 may include an order management subsystem 52 or an (ERP) 54.

In some embodiments, system 200, server 20, and/or at least one user device 10 use cryptographic processes or operations. In some embodiments, system 200, server 20, and/or at least one user device 10 protect privacy of a user associated with at least one user device 10. For example, an individual using user device 10. The server 20 can authenticate the user individual using user device 10-1 or user device 10-2. In some embodiments, server 20, and/or at least one user device 10 encrypt information sent through network interface subsystem 14 or network 50. In some embodiments, server 20, and/or at least one user device 10 encrypt information stored in storage device 13, such as, device metadata 19.

FIG. 3 is a wire frame diagram illustrating an example GUI, GUI 300 for discovery experiences. In some implementations, a processor or controller (e.g., processor 12) presents GUI 300 to a user.

GUIs described herein, like GUI 300, may include one or more user selectable and operable controls (e.g., buttons, dialog boxes, icons, pull-down menus, slides, tool bars) which permit a user to provide input. The input may indicate a desire to change aspects of a discovery experience, e.g., the present experience, or a future experience. In some implementations, the input may include a scope, categorical, or category filter value which comprises one or more filter value that defines the plurality of items and an associated plurality of images to be shown in a GUI such as GUI 300. In some implementations, a category filter is called a population filter. A category filter can include one or more categorical values, e.g., garment type as tights. In some embodiments, the category filter includes ordinal values like size, e.g., size XL. A category filter could include a product category filter, thematic filter, or the like. In some implementations, the input may include a first input material characterization value which a controller uses to order the plurality of images. In some embodiments, the input may be the selection or rejection of an item.

As shown in FIG. 3, GUI 300 includes a first portion 302 and a second portion 304. In some embodiments, first portion 302 of GUI 300 includes a plurality of images 306 associated with a plurality of items. For example, a first image 306-1, a second image 306-2, and a third image 306-3. The plurality of images 306 is associated with a plurality of items, such as, apparel (e.g., tights). In some embodiments, first portion 302 of GUI 300 includes a plurality of controls, such as control 308, so a user may interact with plurality of images 306. For example, a control which when selected shows more options, or a control to select an item. In some embodiments, first portion 302 of GUI 300 includes descriptions, such as description 310, associated with the plurality of images so a user may learn more about the items shown in the plurality of images 306.

In some embodiments, second portion 304 of GUI 300 includes a first plurality of controls 312 for use in a discovery experience. In some implementations, the first plurality of controls 312 include further input controls, such as, control 314.

In some embodiments, second portion 304 of GUI 300 includes a second plurality of controls. For example, the second plurality of controls may include size filter 316. In some embodiments, the second plurality of controls includes one or more category filters. A user providing input through the second plurality of controls defines a scope for the discovery experience. The user may have provided an input through a control in the second plurality of controls. For example, the user provides category filter, such as, a size value through filter 316.

In some embodiments, interacting with one or more of the plurality of images 306 or an element within one or more of the images, for example inset 322, may function as a control to specify a respective material characterization value for a discovery experience. In some embodiments, a user may provide one or more images through a means, such as a camera on a device, and/or uploading that provides a material characterization value or may be analysed to determine and provide a material characterization value.

Returning to the first plurality of controls 312. A user at a user device may use first plurality of controls 312 to select for or filter for one or more items. For example, a user may filter for color. In some implementations, plurality of controls 312 acts as a category filter. By selecting blue in the first plurality of controls 312, a filter is applied, which, in operation, filters for all images associated with tag blue including colors like teal, aquamarine, Shelduck blue, or the like.

A user at a user device may use first plurality of controls 312 to discover items based on one or more visual attributes of constituent materials. For example, a user may specify a color, a texture, an ornamentation, or a combination.

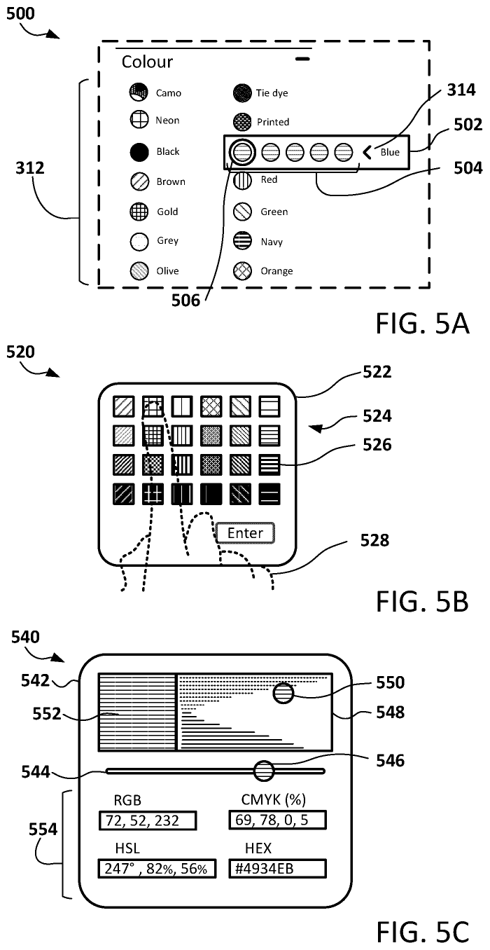

In some implementations, a user at a user device such as user device 10 may use further input controls, such as, control 314 to specify one or more visual attributes of a material. For example, as shown in FIG. 3, the user selects control 314 that pops out a control where the user may input a desirable color for them. Examples of controls are shown and described herein, at least in, FIGS. 4, 5A, 5B, and 5C.

In some embodiments, GUI 300 includes a plurality of insets to the plurality of images 306. For example, image 306-3 is for tights 320 described as “Base Pace High-Rise Crop 23” inches. Image 306-3 includes an inset 322 comprising a swatch. The plurality of insets shows one or more visual attributes of the material included in the associated plurality of items. For example, in image 306-3 the inset 322 shows the tights 320 are grey.

In operation a user may provide an input material characterization value by control 314. The user device may send the input material characterization value to a server, e.g., user device 10-1 sends value through network 50 to server 20. The server orders a plurality of images 306 associated with the plurality of items based on a plurality of distances between each of a plurality of reference material characterization values associated with plurality of images 306 and the input material characterization value provided through control 314. The controller may generate or update the GUI which includes an updated first portion 302 of the GUI comprises the plurality of images associated with the plurality of items in the order based on the plurality of distances between each of the plurality of reference material characterization values and the input material characterization value. For an example see FIG. 4.

FIG. 4 is a wire frame diagram showing a GUI 400. GUI 400 includes the plurality of images arranged in an order based on the plurality of distances between each of the plurality of reference material characterization values and the input material characterization value.

GUI 400 includes a first portion 402 and a second portion 404. In some embodiments, first portion 402 of GUI 400 includes a plurality of images 406 associated with a plurality of items. The plurality of images 406 include an order based on proximity to an input material characterization value.

In some embodiments, second portion 404 of GUI 400 includes a control 408 which when operated specifies one or more visual attributes of a material. In this example, the user has selected a blue swatch 410. The plurality of images 406 are the same as plurality of images 306 but with an order where those images closest in distance to the input material characterization value appear first.

A user may select an image in the plurality of images 406 for further action, such as, acceptance, inspection, rejection. FIGS. 5A, 5B, and 5C show further examples of control 408.

FIG. 5A is a wire frame diagram illustrating an example GUI 500 including a control which when operated specifies one or more visual attributes of a material. GUI 500 may appear in GUI 300 or GUI 400.

The GUI 500 includes a first plurality of controls 312 and control 314. Control 314 is shown in an active state where upon selection by a user renders a pop out window 502. Window 502 includes a plurality of swatches 504. The user may select a swatch to specify a visual attribute of a material. As shown in FIG. 5A, the user has selected a shade of blue e.g., navy blue, as the input material characterization value 506. In response to the selection a processor orders a plurality of images based on a plurality of distances between each of a plurality of reference material characterization values and the input material characterization value (not shown, see FIG. 4).

FIG. 5B is a wire frame diagram illustrating an example GUI 520 including a control which when operated specifies one or more visual attributes of a material. For example, color or texture.

In some embodiments, GUI 520 includes a window 522 comprising a plurality of swatches 524 such as swatch 526. A swatch shows a visual attribute of a material, e.g., color, ornamentation, or texture. In some implementations, a user by their hand 528 and a touch interface selects a swatch to specify a visual attribute of a material. In response to the selection a processor orders a plurality of images based on a plurality of distances. For example, in ascending order of distance between the input material characterization value and each of the plurality of reference material characterization values (not shown, see FIG. 4).

FIG. 5C is a wire frame diagram illustrating an example GUI 540 including a control which when operated specifies one or more visual attributes of a material. In some embodiments, a processor such as processor 12 displays GUI 540 at a user device, such as, user device 10.

In some embodiments, GUI 540 includes a window 542 comprising a plurality of controls and fields. Window 542 includes a slider 544 with a cursor 546 to select a basic color. To select the basic color is like picking a wavelength of monochromatic light, e.g., selecting a point on the outside of the CIE xy chromaticity diagram. Window 542 also includes a reduced color space 548 which in operation displays variations on the basic color. The basic color can be refined with a further selection from amongst colors shown in reduced color space 548. The user may by moving selector 550 in reduced color space 548 to pick a refined color. A swatch 552 shows the selected color (e.g., basic color, refined color) based on positions of cursor 546 and selector 550. Window 542 includes a part 554 which shows numeric values for the selected color.

In GUIs like GUI 540 color may be defined in a color model such as an additive model like RGB (e.g., with colors represented by 8 bits for each of the three component colors), HSL. Color can be hue, hue and shade, shade, or the like. Some implementations define color in a subtractive color model like CMY and CMYK. In some embodiments, color information is stored processor-readable storage device in a format for RGB, HSL, CMY and the like including in hexadecimal format. In GUIs like GUI 520 color may be presented with identifiers as found in standard reference sets, such as, Munsell Books Colors, or Pantone.

GUIs described herein, such as, GUI 300 through GUI 540 inclusive, may include many standard features, for example, a menu bar, close button, minimize button, and help button.

Turning to FIG. 6 which illustrates an example method 600 of operation for a discovery system, such as, system 100. For method 600, as with other methods taught herein, the various acts may be performed in a different order than that illustrated and described. Additionally, the methods can omit some acts, combine acts, split an act, and/or employ additional acts. One or more acts of method 600 may be performed by one or more circuits, for instance one or more hardware processors. In some implementations, method 600 is performed by a controller, e.g., processor 12 of system 200.

Method 600 can begin by invocation from a controller.

At 602, the controller generates a GUI including a plurality of images associated with a plurality of items. For example, the controller generates a GUI (e.g., GUI 300) including a first portion of the GUI (e.g., first portion 302) which includes a plurality of images (e.g., plurality of images 306) associated with a plurality of items. An item is associated with at least one image in the plurality of images. An item is associated with at least one material. Thus each image is associated with at least one material including visual attributes. That is, each image is associated with a visual attribute of a material where the material included is an item shown in the image. The visual attribute is provided by a sensor, for example an imager, e.g., camera 60, bench-top measurement device 62. In some embodiments, at least one item in the plurality of items is for sale. In some embodiments, the GUI is part of a PGE.

At 604, the controller receives from a user device, a first input material characterization value. For example, a first user at a first user device provides a desirable color for an item. The input material characterization value may be provided by selecting a representative image, specifying a value through a GUI, receiving a visual attribute of a material from a sensor, or the like. For examples of GUIs specifying an input value see GUI 400, GUI 500, GUI 520, and GUI 540 shown in FIG. 4, FIG. 5A, FIG. 5B, and FIG. 5C. For examples of blue tights see, for example, FIGS. 3 and 4. In some embodiments, numeric values such as one or more integers or continuous values represent the first input material characterization value. For more examples of material characterization values see, at least, FIG. 5C and FIG. 7A.

At 606, the controller associates a plurality of reference material characterization values with the plurality of images. In some embodiments, a respective reference material characterization value in the plurality of reference material characterization values is associated with a material included in a respective item represented by a respective image in the plurality of images. For example, an item includes a constituent material. In some examples, an image is for an item, the item includes at least one material, and the material has at least one reference material characterization value, such as, a visual attribute. In some embodiments, the controller associates the plurality of reference material characterization values with the plurality of images (604) before the controller receives an input material characterization value (606).

At 606, the controller associates a plurality of reference material characterization values with the plurality of images. In some embodiments, a respective reference material characterization value in the plurality of reference material characterization values is associated with a respective material included in a respective item. Examples of images and items are shown herein at FIG. 3. A respective image in the plurality of images represents the respective item. In some implementations, a respective reference material characterization value in the plurality of reference material characterization values is defined in response to the output of an imager (e.g., user device 10-2, camera 60). For example, the respective image includes a part of the respective image showing the material, and a processor (e.g., hardware processor 12, the controller) extracts one or more visual attributes of the material from the respective image. In some implementations, a sensor (e.g., imager) provides a respective reference material characterization value based on a measurement (e.g., reading, image) that is separate from a respective image in the plurality of images. For example, a respective image may be produced by a fashion photographer in studio and the respective reference material characterization value may be based on the measurement of a sensor in a textile laboratory.

At 608, the controller ranks, sorts, or orders the plurality of images associated with the plurality of items based on a plurality of distances. The plurality of distances is between each of the plurality of reference material characterization values and the input material characterization value, e.g., the first input material characterization value. So for example, a guest may specify a preference for polka dot fabric by selecting a swatch including dots and the controller ranks the plurality of images in distance from the visual attributes of the swatch. In this way the controller aids the guest in discovery.

At 610, the controller generates (e.g., creates, regenerates, updates) the GUI including the plurality of images associated with the plurality of items in the order based on the plurality of distances between each of the plurality of reference material characterization values and the first input material characterization value. In some embodiments, the GUI includes an updated first portion (e.g., first portion 402 in GUI 400) of the GUI with the plurality of images in ascending order of distance from an input material characterization value.

Method 600 ends until invoked again.

Turning to FIG. 7A which illustrates an example method 700 of operation for a discovery system, such as, system 100 or system 200. One or more acts of method 700, as with other methods taught herein, may be performed by one or more circuits, for instance one or more hardware processors. In some implementations, method 700 is performed by a controller, e.g., processor 12 of system 100.

Method 700 can begin by invocation from a controller. At 702 the controller receives a category filter value. In some embodiments, at 702 the controller receives at least one category filter value. For example, the controller receives from a user device through a network (e.g., user device 10 through network 50), one or more category filter values that define the plurality of items and associated categories. Category filter values define the scope the present discovery experience. For example, the category filter value is one or more values of one or more types selected from the group consisting of: gender, target age, brand, category, activity, color, material, popularity, price, promotion, rating, season, size, and theme. In a category filter color and material are categorical values, e.g., nominal or ordinal. In some implementations, until the category filter value is updated the discovery experience is confined to the plurality of images and plurality of items defined by the category filter value. That is, if a guest specified blue suede as a visual attribute and the category filter included garments the results would not show blue suede shoes because shoes are considered apparel and apparel are excluded as not a garment.

At 602, the controller generates a GUI including a plurality of images associated with a plurality of items. In some embodiments, the plurality of images is associated with a plurality of visual attributes of one or more materials, and the plurality of visual attributes is an output of at least one sensor. The plurality of items may reflect the category filter value received at 702. In some embodiments, the controller identifies or generates the plurality of items with input including the category filter value.

At 604, the controller receives a first input material characterization value. In some implementations, the controller receives the first input material characterization value through a network, such as, network 50. The material characterization value may include one or more examples of material characterization values described at, at least, 704, 706, 708, and 710.

At 704, the controller receives the input material characterization value provided by a user through a control included in the GUI. In some embodiments, the GUI includes a second portion (e.g., second portion 304 of GUI 300 in FIG. 3) comprising a control which in operation selects items in the plurality of items. In some embodiments, the controller receives, from the user device, the first input material characterization value provided by the user through the filter included in the GUI.

At 706, the controller receives a numeric value characterizing a visual attribute of a material. The controller can receive a non-numeric value and convert the non-numeric value into a numeric value characterizing a visual attribute of a material. For example, the controller can receive an image, video, binary, greater than, less than, text, or audio type input which may be converted into a numeric value characterizing a visual attribute of a material. In one embodiment, the controller receives user audio input and/or text input based on a user interaction with a chatbot type component associated with the GUI.

At 708, the controller receives a value characterizing at least one color, ornamentation, or texture of a material. In some embodiments, the controller receives a numeric value characterizing at least one color, ornamentation, or texture of a material.

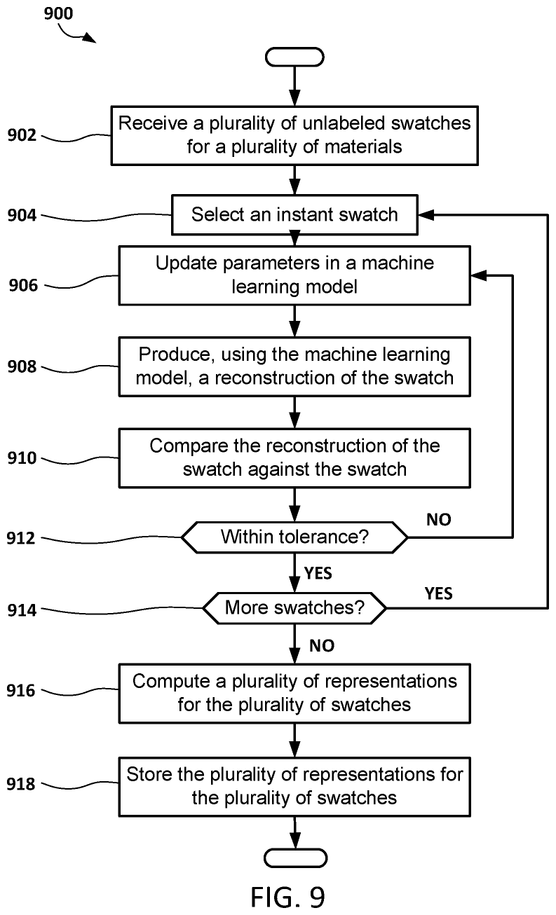

At 710, the controller receives a lower-dimensional representation of an image including a material. The image may show the material. For example, a user selects a swatch and the controller receives lower-dimensional representation of the material included by the swatch. The lower-dimensional representation may be a value, such as a vector, generated by a ML model, e.g., a supervised ML model, classification model, regression model, a k-NN (k-nearest neighbor) model and/or a neural network 26. For further description of lower-dimensional representation of a visual aspect of a material see herein at, at least, FIG. 9. Different ML models can be used. For example, the models can be of one or more type where the type includes one or more of including density-based, distribution-based, centroid based, k-NN (k-nearest neighbor), k-Means, DBSCAN (density-based spatial), hierarchical, Gaussian mixture model, BIRCH (balanced iterative reducing and clustering) method, or the like. Embodiments described herein provide consistent color interpretation. This provides improved computer color interpretation to improve accuracy (e.g. as compared to using a human mind). The technology provides greater accuracy, consistency, scalability, and flexibility than human classification.

Method 700 could include further acts not shown. In some embodiments, method 700 continues at 714. At 714, the controller receives a second input material characterization value. For example, the first input material characterization value could be for color and a second input material characterization value could be for texture.

In some embodiments, method 700 continues as described in reference to FIG. 7B.

Turning to FIG. 7B which illustrates an example method 750 of operation for a discovery system, such as, system 100 or system 200. In some embodiments method 750 follows method 700. In some implementations, method 700 is performed by a controller, e.g., processor 12 of system 100.

At 606, the controller associates a plurality of reference material characterization values with the plurality of images. The controller may as part of, in addition to, or as an alternative to act 606 may include one or more of instances of acts 752, 754, 756, or 758.

At 752, the controller associates at least one material characterization value with at least one material included in an item associated with an image. The controller could, for example, associate one color with the principal material in each item and for some items associate further colors, ornamentation, and texture. In some embodiments, further colors may be associated with one or more of logo, fastener (such as zippers, laces, buttons), trim, shoe sole bottoms, internal linings, decorative pattern or print, contrast stitching, and other apparel aspects. In some embodiments, further colors associated with logos, fasteners (such as zippers, laces, buttons), trim, shoe sole bottoms, internal linings, decorative pattern or print, contrast stitching, and other apparel aspects may be filtered or removed from the set of values associated with the color of the principal material in each item. In one embodiments, the controller associates one color value with the principal material in an item of apparel which is combined with other items of apparel to form an outfit. The identification of the item of apparel used to determine the principal material, and one or more color associated with the principal material, may be based on pre-processing, metadata, product categorization, or the like.

At 754 the controller generates a plurality of distances associated with the plurality of images. For example, the controller generates a plurality of distances between an input characterization value and a plurality of reference material characterization values with the plurality of images. The characterization values may be locations in a feature space, e.g., color space, texture space. For example, the characterization values may include values from a hidden layer in a neural network, values generated by a k-NN model, or lower-dimensional presentations from ML model 26. In an embodiment, the reference material characterization values are locations in a color space, such as the CIELAB color space.

The controller may generate the plurality of distances or a plurality of similarities, collectively for brevity of description called plurality of distances. In some embodiments, the controller generates the plurality of distances using a distance metric like the Manhattan distance (L1 norm), the Euclidean distance (L2 norm), the Chebyshev distance (L∞ norm), weighted versions of these, or the like. The plurality of distances may be values for the inverse or complement to a similarity measure (that is not a distance metric) like cosine similarity, dot product, radial basis function (RBF) kernel, weighted versions of these, or the like.

In some embodiments, the controller generates the plurality of distances using a color distance such as CIE color distance (ΔE*, “Delta E”), sRGB, AEITP, or Rec. ITU-R BT.2124. The CIE color distance could be based on one or more versions such as CIE76, CIE94, or CIEDE2000.

In some embodiments, the material characterization values represent texture values. The controller may generate the plurality of distances using texture values. Texture is a spatially recurring physical element in a material. The recurrence or spatial frequency can be regular or irregular. Texture can be drawn to types including: structured, such as in woven or knitted fabric; oriented (e.g., wood grain or corduroy ridges sitting proud of fabric); granular, such as in cells in foam in a shoe or yoga mat; or random in visual appearance (e.g., fibers in a long nap or pile). In some implementations, the controller generates the plurality of distances using texture values provided by an imager (e.g., user device 10-2, peripheral input device 55, and bench-top measurement device 62). See examples of texture imagers herein at, at least, FIG. 2 and FIG. 8. In some implementations, a plurality of swatches presents options for texture. Swatches may presented in a GUI such as GUI 520 in FIG. 5B.

Texture in images including swatches includes a spatial distribution of tonal variations in the same spectral band. Distance in texture features may be distance or similarity measure. Accordingly, a distance measurement may refer to a numeric value, or another measurement of similarity between features. The distance measurements can refer to different types of similarity measures to indicate how similar, alike or close features are. Embodiments can use different methods for computing the distance measurement or similarity measure. For example, the distance for texture may be based on analysis in spatial-frequency domain, e.g., Fourier transform, Gabor filters, or wavelets. For example, two swatches with the same warp and weft but different colors would have a similar two dimensional spectral representation, e.g., 2D Fourier transform. Change the thread-count (e.g., warp) and the features in at least one direction of the two dimensional spectral representation change. The distance for texture may be based on analysis of the output of an unsupervised ML model or supervised ML model. The distance for texture may be based on analysis of the output at least one sensor, for example, user device 10-2 including a camera and executing-processor executable instructions described herein at, at least, FIG. 2.

Turning again to FIG. 7B, at 756 the controller generates the plurality of distances based on a first input material characterization value. For example, the user provides one input material characterization value that is their requested visual attribute. The user may request an ornamentation like tie dye. See examples of controls to specify tie dye in FIGS. 4 and 5A.

At 758 the controller generates the plurality of distances based on a second input material characterization. For example, the controller generates the plurality of distances based on the first input material characterization value and the second input material characterization value. In some embodiments, the user provides two input material characterization values comprising two visual attributes the user is requesting. Any part of visual attributes may be of the same or different type, for example, bicolor, color and ornamentation. The user may request a color like a specific blue and a range of textures consistent with canvas. In this case the user is less likely to be presented with tights including material comprised of a high thread count synthetic weave plus spandex (e.g., LYCRA®) and more likely to be shown jeans, that is, blue denim trousers.

In some embodiments, the controller generates the plurality of distances associated with the plurality of images (e.g., plurality of images 306) based on a feature space that includes two or more of color, ornamentation, or texture. In some embodiments, the controller generates the plurality of distances associated with the plurality of images based on a weighted (e.g., equal, unequal) combinations of a first distance from a first feature space and a second distance from a second feature space. Examples of feature spaces are described herein at, at least, FIG. 11.

At 608, the controller orders the plurality of images associated with the plurality of items based on a plurality of distances in ascending distance value. Equivalently, the controller orders the plurality of images in descending order of similarity value. The images associated with items and materials are ordered such that earlier images are closer to the input material characterization value provided by the user. In this way, the controller provides the user the items listed in a way that aids discovery from a starting point provided by the user. In some implementations, if the input material characterization is a middling value the order may include images where the characteristic visual attribute alternates over successive images. For example, lighter shade then darker shade. The order reflects proximity to the input material characterization value but not proximity to the adjacent images.

At 610, the controller generates the GUI including the plurality of images associated with the plurality of items in the order based on the plurality of distances between each of the plurality of reference material characterization values and the first input material characterization value. Examples and details of this presentation are further described herein at, at least, FIGS. 4 and 6.

At 760, the controller stores the plurality of distances. In some embodiments, the controller stores the plurality of distances on at least one non-transitory processor-readable storage device, e.g., storage device 13. The plurality of distances may be between each of a plurality of reference material characterization values associated with a plurality of images and an input material characterization value, e.g., first or second input material characterization value.

Method 700 or method 750 end until invoked again.

Turning to FIG. 8 which illustrates an example method 800 of operation for a discovery system, such as, system 100 or system 200. In some implementations, method 800 is performed by a controller, e.g., processor 12 of system 100. In some implementations, method 800 is a method of operation in a system including a user device comprising an imager (e.g., user device 10-2, camera 60).

Method 800 can begin by invocation from a controller. At 802 the controller receives a plurality of swatches for a plurality of materials. For example, the controller receives an image of a material, produced by an imager in a user device. In some embodiments, the controller receives a plurality of images for a plurality of materials. For example, the swatches are images. In some implementations, a second user (e.g., an employee) is associated with a user device that includes an imager (e.g., camera 60) and the second user produces the plurality of swatches with the imager.

At 804-814, the controller iterates over the plurality of swatches for the plurality of materials. In some implementations, there is a first iteration over each swatch and a second iteration over each visual attribute (e.g., color, ornamentation, texture). At 804, the controller selects a present or instant swatch and an instant visual attribute.

At 806, the controller extracts a material characterization value for the instant swatch and instant visual attribute. In some embodiments, the controller extracts from the instant swatch a dominant visual attribute value. In some embodiments, the controller assigns a material characterization value to the material based on the dominant visual attribute value.

At 808, the controller associates the material characterization value with one or more entities. Examples of entities include a material, an item including the material, an image of the item, and an image of the material.

In some embodiments, the controller associates an item including the material with the material characterization value. In some embodiments, the controller, at 808, associates an image with the item including the material.

In some embodiments, the controller assigns a numeric material characterization value. For example, the material characterization value is a non-nominal value. In some embodiments, the controller assigns a material characterization value based on a visual attribute such as color of the material, ornamentation of the material, and texture of the material.

At 810, the controller stores, on the storage device, a record including the material characterization value. In some embodiments, the record includes a first identifier of the material. The record may include a second identifier of the swatch. In some embodiments, the record includes a third identifier of an item. In some embodiments, the record includes a fourth identifier of an image associated with the item. The swatch and the image may be the same or different. See herein at, at least, FIG. 6 including actions of controller at 606. In some embodiments, the controller stores the record on at least one non-transitory processor-readable storage device, e.g., storage device 13.

At 812, the controller checks for a further visual attribute in the instant swatch. At 812—Yes, method 800 continues at 804 for another visual attribute. At 812—No, method 800 continues at 814.

At 814, the controller checks for a further swatch in the plurality. At 814—Yes, method 800 continues at 804 for another swatch. At 814—No, in some embodiments, method 800 ends until invoked again.

Turning to FIG. 9 which illustrates an example method 900 of operation for a discovery system, such as, system 200. In some implementations, method 900 is performed by a controller, e.g., processor 12 of system 200. In some implementations, method 900 is a method of operation in a system including an ML model 26.

Method 900 can begin by invocation from a controller. A controller can be an electronic device (e.g., as part of a control system) that generates control signals as output to control actions of the device or another device. For example, a controller can generate control signals with code that controls operations of a processor or peripheral device, actuate components of a device, and so on. A controller can be a chip, card, an application, or hardware device. A controller can manage and connect devices, or direct the flow of data between devices to provide an interface and manage communication. For example, a controller can be an interface component between a central processing unit and a device being controlled. A controller can be a type of input device that generates and transmits control commands to control operations of a computer, a component, or other device. There are different types of controllers. Controllers automatically control products, embedded systems, and devices using control commands. A controller can have one or more processors, memory and programmable input/output peripherals. A sensor can be an device that detects or measures a physical property (e.g., property of a material), records the detections or measurements, or transmits the detections or measurements. A sensor is a device that responds to a physical stimulus and generates a resulting measurement. A sensor can be a device, machine, or subsystem that detects events or changes in its environment, produces an output signal associated with sensing physical properties, and sends the information to other electronics, such as a hardware processor. At 902 the controller receives a plurality of unlabeled swatches for a plurality of materials. For example, the controller receives an image of a material, produced by an imager (e.g., camera 60). At 904-914, the controller iterates over the plurality of unlabeled swatches. The controller uses an ML model at 904-914, for example. In some embodiments, the controller trains the ML model, provides input to, and receives output, from a ML model.

At 904, the controller selects an instant swatch. On further iterations, at 904, the controller selects a new swatch.

At 906 the controller updates a plurality of parameters in an ML model. In one embodiment, the ML model is a neural network. The controller may use backpropagation, gradient descent, or the like. In one embodiment, the ML model is a k-NN model. In one embodiment, the neural network, 26, may be an autoencoder, variational autoencoder, convolutional neural network, or other suitable ML model, such as, a deep learning model. The ML model can encode input data into a lower-dimensional representation of the input data. The ML model can extract valuable information and reduce the dimensionality of data.

In some implementations, the ML model includes one or more latent or hidden layers. For example, a hidden layer overlying an input layer, e.g., connected to the input layer, coupled to the input layer through one or more intermediate layers. In some examples, the hidden layer underlies an output layer, e.g., connected to the output layer, coupled to the output layer though one or more further intermediate layers. In some implementations, the hidden layer is placed between and coupled to an encoder and a decoder.

In some embodiments, the ML model accepts, at an input layer, a swatch and provides a reconstruction of the swatch at an output layer. A hidden layer, when present, contains a hidden, latent, or lower-dimensional representation of the input provided to the input layer. If present in the ML model, an encoder (e.g., one or more layers and connections) transforms input data into a lower-dimensional representation. If present in the ML model, decoder transforms the lower-dimensional representation into a reconstruction.

At 908, the controller produces, using the ML model, a reconstruction of the swatch. At 910, the controller compares the reconstruction of the swatch against the swatch.

At 912, the controller checks if the difference between the swatch and the reconstruction of the swatch is within tolerance. At 912—No, method 900 continues at 906 when the controller updates the plurality of parameters in the ML model. At 912—Yes, method 900 continues at 914. In some embodiments, method 900 includes checking for a stop condition at 912, for example, number of iterations.

At 914, the controller checks for a further swatch in the plurality of unlabeled swatches. At 914—Yes, method 900 continues at 904 for another swatch. At 914—No, method 900 continues at 916. In some implementation, method 900 includes model selection or hyperparameter tuning in one or more further (e.g., outer) sets of iterations.

At 916, the controller generates a plurality of representations for the plurality of swatches. In some embodiments, the controller generates a plurality of hidden representations for the plurality of swatches, e.g., lower-dimensional representation.

At 918, the controller stores the plurality of representations for the plurality of swatches. In some embodiments, the controller stores the plurality of representations for the plurality of swatches.

In some implementations, the plurality of representations for the plurality of swatches is the reference material characterization values. In some implementations, a representative representation in the plurality of representations for the plurality of swatches includes values from a hidden layer in an ML model. A representation may be values from a hidden layer in an ML model. In some embodiments, a representative representation in the plurality of representations for the plurality of swatches principally includes a one-dimensional vector of floating point values (e.g., double). Examples of vector length include powers of two, e.g., 128, 256, and 512. Examples of vector length include length logarithmic in size of input, N, e.g., logₐ N or [logₐ N] where a could be 2, 3, or 10. In some implementations, the vector is a lower-dimensional representation of an input.

In some embodiments, method 900 ends until invoked again.

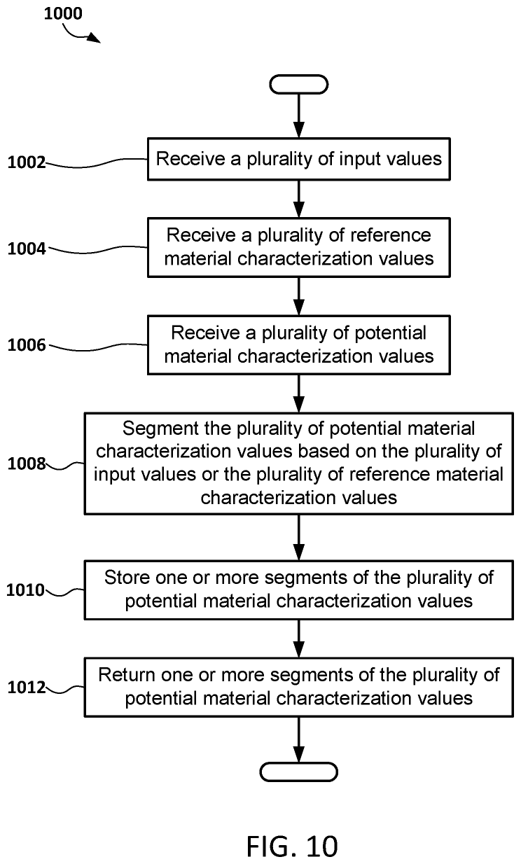

FIG. 10 is a flow-diagram illustrating an implementation of a method 1000 of operation for system including at least one record summarizing a plurality of discovery experiences, such as, system 100. In some implementations, method 900 is performed by a controller, e.g., processor 12 of system 100.

Method 1000 can begin by invocation from a controller. At 1002, the controller receives a plurality of query or input values. In some embodiments, at 1002 the controller receives one or more records containing, the plurality of input values. A respective input value in the plurality of input values is associated with a user (e.g., a guest). A respective input value specifies one or more visual attributes.

At 1004, the controller receives a plurality of reference material characterization values. Method 1000 may be performed without the plurality of reference material characterization values. The controller may receive one or more records stored on tangible storage device, the records including the plurality of reference material characterization values. The plurality of reference material characterization values may be associated with a plurality of images, a plurality of items, or a plurality of materials as described herein.

At 1006, the controller receives a plurality of potential material characterization values. The plurality of potential material characterization values could represent samples from a supplier. In some embodiments, controller receives a plurality of potential material characterization values representing additional or alternative items or materials for items.

The plurality of potential material characterization values may include at least three cases: non-redundant values and meeting demand, non-redundant values and not meeting demand, and redundant values. See, at least, FIG. 13 for a further description of method 1000.

At 1008, the controller segments the plurality of potential material characterization values based on the plurality of input values, or the plurality of reference material characterization values. In some implementations, the controller segments based on input including the plurality of potential material characterization values based on the plurality of input values, or the plurality of reference material characterization values.

In some implementations, the controller in method 1000 after 1008 (and optionally including more of method 1000 such as 1010 or 1012) has performed a whitespace or more inclusively an empty space analysis. The one or more segments of the plurality of potential material characterization values helps identity based on input received from one or more sensors.

At 1010, the controller stores one or more segments of the plurality of potential material characterization values. For example, the controller stores a first plurality of the plurality of potential material characterization values. The first plurality of the plurality of potential material characterization values represents non-redundant values and meeting demand.

At 1012, the controller returns one or more segments of the plurality of potential material characterization values. In some embodiments, method 1000 ends until invoked again.

In an aspect, there is provided a method of operation in a system including at least one processor, and a storage device in communication with the at least one processor. The method incudes receiving, by the at least one processor, a plurality of query values, and receiving, by the at least one processor, a plurality of potential material characterization values. The method incudes segmenting, by the at least one processor, the plurality of potential material characterization values into at least one segment based on the plurality of query values, and storing, by the at least one processor in the storage device, the at least one segment. The method optionally further includes receiving, by the at least one processor, a plurality of reference material characterization values, and segmenting, by the at least one processor, the plurality of potential material characterization values based on the plurality of query values, and the plurality of reference material characterization values. The method optionally further includes returning, by the at least one processor, the one or more segments of the plurality of potential material characterization values.

In a further aspect, there is provided a system including at least one processor, and at least one non-transitory processor-readable storage device in communication with the at least one processor. The at least one non-transitory processor-readable storage device stores processor-readable data and processor-executable instructions which, when read or executed by the at least one processor, cause the at least one processor to receive a plurality of query values, and receive a plurality of potential material characterization values. When executed, the processor-executable instructions further cause the at least one processor to segment the plurality of potential material characterization values into at least one segment based on the plurality of query values, and store, in the non-transitory processor-readable storage device, the at least one segment.

FIG. 11 is a schematic diagram illustrating various aspects of a feature space 1100 in accordance with the present disclosure. Feature space 1100 and other feature spaces described herein schematically illustrate in aggregate visual attributes of materials, lower-dimensional representation of images of materials, and the like. Feature space 1100 is defined by a first border 1102 aligned with a first direction (e.g., vertical) and a second border 1104 aligned with a second direction (e.g., horizontal). The first and second directions may be orthogonal. The span of the first direction and the second direction as bounded by the borders (e.g., first border 1102 and second border 1104) define feature space 1100 representing at least one visual attribute of a material. A location (e.g., point) in feature space could be a color, ornamentation, or texture. In some embodiments, the feature space represents texture using pattern values associated with longitudinal and/or cross-section views of one or more fabric element.

For the purpose of illustration, feature space 1100 includes a plurality of material characterization values 1106 for a plurality of materials. The materials may be available materials, materials included in items, or the like. The plurality of material characterization values is shown as black dots, for example, material characterization value 1106-1. The plurality of material characterization values 1106 may be associated with the reference material characterization values described herein. For example, material characterization value 1106-1 may be for the grey material included in “Base Pace High-Rise Crop 23” inch tights shown in image 306-3.

For the purpose of illustration, feature space 1100 includes a plurality of boundaries (e.g., boundary 1108) that define a plurality of cells (e.g., cell 1110). The area in each cell is closest to the material characterization values enclosed within the cell as measured by a distance metric. As shown, feature space 1100, the plurality of boundaries (e.g., boundary 1108), and plurality of cells 1110 are based on Euclidean distance.

Feature space 1100 may include a query or input value 1112. For example, a first input material characterization value, such as, a shade of grey. The input value 1112 has a distance to the plurality of material characterization values 1106. A set of representative distances 1114 is shown. As the input value 1112 is in cell 1110 the closest material characterization value is material characterization value 1106-1.

FIG. 12 is a schematic diagram illustrating various aspects of a feature space 1200 in accordance with the present disclosure. As described in FIG. 11, feature space 1200 includes a first border 1102, a second border 1104, a plurality of material characterization values 1106, and a plurality of boundaries (e.g., boundary 1108) defining a plurality of cells (e.g., cell 1110).

Feature space 1100 may include a plurality of query or input values 1112 (e.g. input values 1112-1, 1112-2. 1112-3). For example, a input value 1112 has a distance to the plurality of material characterization values 1106 (e.g. input values 1106-1, 1106-2).

For the purpose of illustration, feature space 1200 includes a plurality of tolerances 1202 for the plurality of material characterization values 1106. The plurality of tolerances 1202 indicate how close locations may be in feature space 1200 to be regarded as the same value. For example, tolerance 1202-1 shows input value 1112-1 is not equivalent to material characterization values 1106-1.

In some embodiments, the plurality of tolerances 1202 is empirically generated. The plurality of tolerances 1202 may be generated by preference manager 28 from preference data 34 shown in FIGS. 1 and 2. The plurality of tolerance 1202 may vary in size, eccentricity, isotropy, or the like across feature space 1200. For example, tolerances 1202-1, 1202-2, 1202-3, and 1202-4 differ in size. As shown plurality of tolerances 1202 are anisotropic in that elliptical major and minor axis differ. Tolerance 1202-2 has a further example of anisotropy in orientation of major axis aligns to different direction than for major axes in rest of plurality of tolerances 1202. For example, human vision is more discriminative in blue hues to the tolerance in that region where feature space 1200 is tighter. As another example, FIG. 12 shows a group of tolerances 1204 (e.g. a plurality of smaller sized tolerances tightly clustered) in the top right corner of the feature space 1200.

For illustration, feature space 1100 includes a plurality of query or input values 1112. Some of these are within the plurality of tolerances 1202 such as value 1112-3.

In some embodiments, the plurality of tolerances 1202 provides a guide as to the closest material characterization value for an available material. See, for example, FIG. 13.

FIG. 13 is a schematic diagram illustrating various aspects of a feature space 1300 in accordance with the present disclosure. As described in FIGS. 11, 12 and 13. Feature space 1300 includes a first border 1102, a second border 1104, a plurality of material characterization values 1106, a plurality of tolerances 1202, and a plurality of input values 1112.

In some embodiments, feature space 1300 is used for whitespace or more inclusively empty space analysis. The plurality of material characterization values 1106 and the plurality of tolerances 1202 show coverage of feature space 1300. The parts of feature space 1300 outside of the plurality of tolerances 1202 represent a lack of coverage and a potential for unmet demand. The location of the plurality of input values 1112 quantifies the demand.

In some embodiments, a plurality of potential material characterization values is included in feature space 1300. These could represent samples from a supplier. The plurality of potential material characterization values includes at least three cases. A first plurality of material characterization values 1302. Values in the first plurality of material characterization values 1302, within a tolerance, cover one or more of the plurality of input values 1112. The tolerance may be associated with plurality of material characterization values 1302, plurality of input values 1112, or both. In some embodiments, the coverage is at or above a predetermined number of input values. Examples include material characterization value 1302-1 and material characterization value 1302-2. In FIG. 13 values 1302 are shown as encircled plus symbols. The plurality of material characterization values 1302 represent materials that serve a quantified need as expressed by guests.

A second plurality of material characterization values 1304 in the plurality of potential material characterization values, within a tolerance cover, zero or up to a predetermined number of the plurality of input values 1112. For example, values 1304 cover few requested visual attributes. Examples include material characterization value 1304-1 and material characterization value 1304-2. As shown, these are denoted by the “no” or “ghostbusters” symbol. These values in the second plurality of material characterization values 1304 represent materials that, while available, do not meet needs expressed by guests.

The plurality of potential material characterization values includes redundant values: a third plurality of material characterization values 1306. As shown, these are denoted by open circles. For example, value 1306-1 overlaps within a tolerance with an existing material characterization value in the plurality of material characterization values 1106.

In an embodiment, the plurality of potential material characterization values and/or tolerance ranges is processed, pre-processed, or post-processed using clustering logic and/or models of one or more type where the type includes one or more of density-based, distribution-based, centroid based, k-NN, k-Means, DBSCAN (density-based spatial), hierarchical, Gaussian mixture model, BIRCH (balanced iterative reducing and clustering) method, or the like. In an embodiment, image content is preprocessed/de-noised. This pre-processing/de noising may include identifying the color of the principal material associated with a principal item of apparel which may include filtering/de-prioritizing features such as human bodies, backgrounds, foregrounds, non apparel items represented, non-primary items of apparel represented (e.g., another item of apparel depicted in an outfit with an item of apparel identified as primary, colored features associated with a secondary detail element such as stitches/fasteners/logos), features/feature vectors identified, LAB values assigned, Classification and/or regression algorithm such as k-NN algorithm, major color centroids (3-4 colors, central value in a cluster), built for inventory table (style option/color), user picks “hue”, Lab table closest distance, may be used to perform calculations.

In some embodiments, a color value identified by these methods and/or systems may be associated with a user filter, user profile, user search history, metadata associated with a user, anonymized navigational histories, anonymized purchase histories, a combination or the like. This color value may be used to refine and categorize data, data series, and the like. For example, users may have preferred colors associated with their search history and/or used as a value in determining product page display in a digital retail environment. In some embodiments, a color value is an example material characterization value.

For methods taught herein, the various acts may be performed in a different order than that illustrated or described. Additionally, the methods can omit some acts, combine acts, split an act, and/or employ additional acts. For methods taught herein, the various acts may be performed by one or more circuits, for instance one or more hardware processors. Computer implemented methods taught herein include methods 600, 700, 750, 800, 900 and 1000 described in relation to illustrations in FIGS. 6, 7A, 7B, 8, 9, and 10 that involve acts performed by one or more circuits, for instance one or more hardware processors.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms “coupled”, “coupling”, or “connected” can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

The technical solution of embodiments may be in the form of a software product. The software product may be stored in a non-volatile or non-transitory storage medium. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is further contemplated that any part of any aspect or embodiment discussed in this specification can be implemented or combined with any part of any other aspect or embodiment discussed in this specification.

1. A computer system for updating a graphical user interface by automatically moving images associated with apparel items, the system comprising:
a user device having a graphical user interface including a first portion of the graphical user interface wherein the first portion comprises a plurality of images associated with a plurality of apparel items;
at least one controller performing measurements;
at least one processor communicatively coupled to the user device; and
at least one non-transitory processor-readable storage device communicatively coupled to the at least one processor, the at least one non-transitory processor-readable storage device storing processor-readable data and processor-executable instructions, wherein the processor-readable data comprises a plurality of images associated with a plurality of apparel items, and a plurality of reference material characterization values associated with the plurality of images, and wherein the processor-executable instructions, when executed by the at least one processor, cause the at least one processor to:
transmit control signals to the at least one controller to perform measurements;
receive output from the measurements performed by the at least one controller; and
define the plurality of reference material characterization values associated with the plurality of apparel items in response to the output from the one or more sensors which performed the measurements;
associate a respective reference material characterization value in the plurality of reference material characterization values with a material included in a respective apparel item represented by a respective image in the plurality of images;
receive a first input material characterization value;
order the plurality of images associated with the plurality of apparel items based on a plurality of distances between each of the plurality of reference material characterization values and the first input material characterization value; and
automatically update, at the user device, the graphical user interface including an updated first portion of the graphical user interface by automatically moving the plurality of images associated with the plurality of apparel items included in the first portion of the graphical user interface based on the order, the updated first portion of the graphical user interface comprising the plurality of images associated with the plurality of apparel items in the order based on the plurality of distances between each of the plurality of reference material characterization values and the first input material characterization value.

2. The system of claim 1, further comprising at least one sensor performing a portion of the measurements, and wherein the at least one processor transmits control signals to the at least one sensor to perform the measurements, and receives output from the measurements performed by the at least one sensor.

3. The system of claim 1, wherein the at least one processor computes the first input material characterization value using a machine learning model to extract one or more visual attributes of a material and generate a processor readable representation of the one or more visual attributes.

4. The system of claim 1, wherein the at least one processor defines one or more of the plurality of reference material characterization values using a machine learning model to extract one or more visual attributes of a material and/or swatch and generate a processor readable representation of the one or more visual attributes.

5. (canceled)

6. The system of claim 1, wherein the first input material characterization value is one or more of a lower-dimensional representation of the one or more visual attributes of the material, a value characterizing a visual attribute of a material, a numeric value characterizing the visual attribute of the material.

7. The system of claim 3, wherein the machine learning model is selected from the group consisting of a supervised machine learning model, a K-nearest neighbour model and a neural network.

8. The system of claim 1, wherein one or more of the plurality of reference material characterization values comprise locations in a colour space.

9. The system of claim 1, wherein:
the user device is associated with a user;
the graphical user interface includes a second portion comprising a control which in operation specifies a respective value of a respective visual attribute; and
when executed, the processor-executable instructions further cause the at least one processor to:
receive the first input material characterization value provided by the user through the control included in the graphical user interface.

10. (canceled)

11. (canceled)

12. (canceled)

13. The system of claim 1, wherein when executed, the processor-executable instructions further cause the at least one processor to:
receive from the user device an input including a category filter value; and
generate the plurality of items from the input including the category filter value.

14. (canceled)

15. The system of claim 1, wherein when executed, the processor-executable instructions further cause the at least one processor to:
compute the plurality of distances between each of the plurality of reference material characterization values and the first input material characterization value, with an input including the plurality of reference material characterization values and the first input material characterization value.

16. The system of claim 2 wherein the one or more sensors comprise an imager, wherein the respective reference material characterization value in the plurality of reference material characterization values is defined in response to an output of the imager.

17. A method for updating a graphical user interface by automatically moving images associated with apparel items, the method for operation in a system including at least one processor, and a user device in communication with the at least one processor, the method comprising:
generating, by the at least one processor, a graphical user interface including a first portion of the graphical user interface, wherein the first portion includes a plurality of images associated with a plurality of apparel items;
receiving, by the at least one processor from the user device, a first input material characterization value;
associating, by the at least one processor, a plurality of reference material characterization values with the plurality of images, wherein:
a respective reference material characterization value in the plurality of reference material characterization values is associated with a material included in a respective apparel item represented by a respective image in the plurality of images; and
a respective reference material characterization value in the plurality of reference material characterization values is defined in response to output of one or more sensors;
ordering, by the at least one processor, the plurality of images associated with the plurality of apparel items based on a plurality of distances or similarity measures between each of the plurality of reference material characterization values and the first input material characterization value; and
automatically updating, by the at least one processor, the graphical user interface to include an updated first portion of the graphical user interface by automatically moving the plurality of images associated with the plurality of apparel items included in the first portion of the graphical user interface based on the ordering, the updated first portion of the graphical user interface comprising the plurality of images associated with the plurality of apparel items ordered based on the plurality of distances or similarity measures between each of the plurality of reference material characterization values and the first input material characterization value.

18. The method of claim 17 further comprising:
transmitting control signals to the one or more sensors to perform measurements;
receiving output of the measurements from the one or more sensors; and
defining the plurality of reference material characterization values associated with the plurality of items in response to the output from the one or more sensors which performed the measurements.

19. The method of claim 17, wherein:
the user device is associated with a user, and
the graphical user interface includes a second portion comprising a control to specify a respective value for a respective visual attribute, and
the method further comprising:
receiving, by the at least one processor from the user device, the first input material characterization value provided by the respective value for a respective visual attribute of a material specified by the control included in the graphical user interface.

20. (canceled)

21. The method of claim 20, wherein the value characterizing the visual attribute of the material is a numeric value characterizing the visual attribute of the material.

22. (canceled)

23. The method of claim 20, wherein receiving the value characterizing the visual attribute of the material, further comprises:
receiving, by the at least one processor, a value characterizing at least one of one or more color of the material, one or more of ornamentation of the material, one or more texture of the material.

24. (canceled)

25. The method of claim 17 further comprising:
receiving, by the at least one processor from the user device, an input including a category filter value wherein the category filter value is one or more values for a type selected from a group consisting of: gender, target age, availability, brand, category, activity, color, material, popularity, price, promotion, rating, season, size, and theme; and
generating, by the at least one processor, the plurality of items from the input including the category filter value.

26. (canceled)

27. The method of claim 17 further comprising:
computing, by the at least one processor, the plurality of distances between each of the plurality of reference material characterization values and the first input material characterization value, using input including the plurality of reference material characterization values and the first input material characterization value.

28. The method of claim 17 further comprising:
receiving, by the at least one processor from the user device, a second input material characterization value; and
generating, by the at least one processor, the plurality of distances with input including:
the plurality of reference material characterization values,
the first input material characterization value, and
the second input material characterization value.

29. The method of claim 17, wherein the system further includes at least one non-transitory processor-readable storage device communicatively coupled to the at least one processor, and the method further comprises:
storing, at the at least one non-transitory processor-readable storage device, the plurality of distances between each of the plurality of reference material characterization values and the first input material characterization value.

30. The method of claim 17 further comprising:
displaying, at the user device, the updated graphical user interface.
training the machine learning model for processing the visual attributes using the output dataset including plurality of parameters.

31-56. (canceled)

57. A computer implemented method for updating a graphical user interface by automatically moving images associated with apparel items and training a machine learning model for processing visual attributes of a material in a system including at least one processor and an imager, the method comprising:
receiving, by the at least one processor, an input dataset including a plurality of images of a plurality of materials from the imager;
for each image in the plurality of images, generating successive reconstructions for each image until reaching a stop condition;
for each image in the plurality of images, generating a lower-dimensional representation each material included in each image;
updating a plurality of parameters for the machine learning model for processing visual attributes;
producing an output dataset including plurality of parameters for the machine learning model for processing the visual attributes;
training the machine learning model for processing the visual attributes using the output dataset including plurality of parameters;
computing at least one of a first input material characterization value and one or more of a plurality of reference material characterization values using the machine learning model to extract one or more visual attributes and generate a processor readable representation of the one or more visual attributes; and
automatically updating, by the at least one processor, a graphical user interface by automatically moving a plurality of images associated with a plurality of apparel items included in the first portion of the graphical user interface by ordering the plurality of images associated with the plurality of apparel items based on a plurality of distances or similarity measures between each of the plurality of reference material characterization values and the first input material characterization value.
